(19) United States
(12) Patent Application Publication
(10) Pub. No.: US 2001/0047302 A1
(43) Pub. Date: Nov. 29, 2001

(54) Panel displaying method of order receiving POS terminal and order receiving POS terminal

(75) Inventors: Shinichi Yoshinaga, Kawasaki-shi (JP); Susumu Tanaka, Kawasaki-shi (JP)

Correspondence Address: ARENT FOX KINTNER PLOTKIN & KAHN, 1050 CONNECTICUT AVENUE, N.W., SUITE 600, WASHINGTON, DC, 20036, US

(73) Assignee: Fujitsu Limited

(21) Appl. No.: 09/904,850

(22) Filed: Jul. 16, 2001

Related U.S. Application Data
(63) Continuation of application No. 08/802,273, filed on Feb. 19, 1997.

(30) Foreign Application Priority Data
May 14, 1996 (JP) HEI 8-119402

(51) Int. Cl. G06F 17/60; G06G 1/12

(52) U.S. Cl. 705/15; 705/16; 705/21

(57) ABSTRACT

A panel displaying method of an order receiving POS terminal is used to receive an order for an article by a customer in, for example, a fast-food restaurant. The panel displaying method, wherein the POS terminal includes a display unit that displays a touch panel formed of plural keys operated when a customer orders an article comprises the step of pop-up displaying on the display unit the touch panel formed of keys each corresponding to an optional item when the article is ordered. The panel displaying method permits easy operation, registering optional items, and updating a menu with no troubles.

### BACKGROUND OF THE INVENTION

1) Field of the Invention

The present invention relates to a panel displaying method of an order receiving POS (Point-Of-Sales) terminal and an order receiving POS terminal each suitable for a job of receiving orders from customers in, for example, fast-food restaurants.

2) Description of the Related Art

Generally, order receiving POS (Point-Of-Sales) terminals have been used for performing an account job in shops such as restaurants, particularly, fast-food chains which quickly prepare and offer articles on the spot in response to the orders from customers.

That is, the operator operates a POS terminal to receive orders for articles from customers and performs an account job using the POS terminal.

The restaurants such as fast-food chains including hamburger shops generally use a POS terminal 100 shown in FIG. 28. The POS terminal 100 shown in FIG. 28 includes a sheet key panel 101 where various operation keys and menu entry keys are arranged on the sheet, and a display 102 which displays operation information and the like.

In the sheet key panel 101, the sheet on which the various operation keys and menu entry keys are placed is arranged on plural touch sensors which detect that a finger touches on a key arranged corresponding to the position of each key.

In such an arrangement, an operator performs various procedures and menu entries (article registering operation) by touching his finger on a key on the sheet key panel 101. The detail statement on an article registered via menu entry key in response to, for example, a customer's order is displayed on a display 102.

In order to perform an accounting process, “a ten key” and “a subtotal key” are allocated as operation keys for various procedures to the sheet key panel 101. In addition, menu entry keys are allocated for respective articles to register each menu such as hamburger and potato.

In fast-food restaurants, set articles in which plural regular items are combined are often sold at a value giving a discount feeling. For example, a set of article formed of “hamburger”, “potato”, and “drink” selectable from plural kinds of drink is sold as a set article. In this case, a menu entry key can be previously allocated as a set article named, for example, “Hamburger set”.

In restaurants which sell menus such as “Morning menu” or “Lunch menu” which are changed according to time slot, the “Morning menu” and “Lunch menu” can be allocated as menu entry keys in the same sheet key panel 101.

Numeral 103 represents a display for customers which displays order information or paid and registered money to a customer.

In fast-food restaurants such as hamburger shops, an operator operates the POS terminal 100 with the above-mentioned configuration to register articles ordered by a customer via the sheet key panel 101 and to prepare articles. Thereafter, by collating the detail statement on the display 102 displayed through the article registering procedure with the prepared articles, the ordered articles are offered to the customer while the accounting process is performed.

However, the general order receiving POS terminal has a problem in that a large number of menu entry keys corresponding to all articles to be sold must be allocated on the sheet key panel 101, thus complicating its operation.

Further, when menus are updated by changing allocation to the sheet key panel 101, the sheet must be replaced on the sheet key panel 101. Hence it is troublesome for an operator operating the POS terminal to update the sheet.

For example, in the case of the sale of a set articles including an optional item together with a main item, the optional item must be registered using menu entry keys. Further, it is necessary that the inputting procedure does not impair the entire operation flow.

### SUMMARY OF THE INVENTION

The present invention is made to overcome the above mentioned problems. An object of the present invention is to provide an order receiving POS terminal that can register an optional item in a simplified procedure, without impairing the entire operational flow.

Another object of the present invention is to provide a panel displaying method that can register an optional item in a simplified procedure, without impairing the entire operational flow.

In order to achieve the above objects, according to the present invention, the panel displaying method of an order receiving POS (Point-Of-Sales) terminal, wherein the POS terminal includes a display unit that displays a touch panel formed of plural keys operated when an order for an article from a customer is received, is characterized by the step of pop-up displaying on the display unit a touch panel formed of keys each corresponding to an optional item when said article is ordered.

According to the present invention, when an article is registered, a touch panel formed of keys each corresponding to an optional item can be pop-up displayed on the display unit. Hence, the pop-up-displayed touch panel can be operated without impairing the entire operational flow when the order receiving POS terminal is operated while the original screen image is left. The invention has the advantage of remarkably improving the operability as well as the serviceability to an operator.

According to the present invention, the panel displaying method for an order receiving POS (Point-Of-Sales) terminal, wherein the POS terminal includes a display unit that displays a touch panel formed of plural keys operated when an order for an article from a customer is received, is characterized by the step of displaying a base item in a set article as a registered article on the display unit and pop-up displaying on the display unit a touch panel formed of keys each corresponding to an optional item other than the base item in the set article, when the set article including plural items is ordered.

According to the present invention, a base item in a set article is displayed as a registered article on the display unit when the set article including plural items is ordered and a touch panel formed of keys each corresponding to an optional item other than the base item in the set article is pop-up displayed on the display unit. Hence, since the detail statement of an optical item in a set article can be displayed on the display 5, the same advantage as mentioned above can be obtained. Moreover, sales management can be accurately performed by registering all items of a set article.

In this case, the pop-up display on the display unit can be released when the optional item other than the base item is selectively registered.

According to the present invention, since the pop-up display on the display unit can be released when the optional item other than the base item is selectively registered, an operator's erroneous entry can be prevented so that the operability can be remarkably improved.

Further, according to the present invention, the panel displaying method for an order receiving POS (Point-Of-Sales) terminal, wherein the POS terminal includes a display unit that displays a touch panel formed of plural keys operated when an order for an article from a customer is received, is characterized by the steps of displaying the same kind of articles as a category key on the display unit, and pop-up displaying on the display unit a touch panel formed of keys corresponding to the kind of articles belonging to the category key as an article menu when the category key is operated.

According to the present invention, the same kind of articles are displayed as a category key on the display unit, and a touch panel formed of keys corresponding to the kind of articles belonging to the category key is pop-up displayed as an article menu on the display unit when the category key is operated. Hence, when plural articles are categorized as the same kind of articles, the keys for article registration displayed on the order entry screen can be united as a single key. The present invention has the advantage of contributing to reducing the number of keys on the order entry screen, thus greatly improving the screen visibility and the operator's operability.

Further, according to the present invention, the panel displaying method for an order receiving POS (Point-Of-Sales) terminal, wherein the POS terminal includes a display unit that displays a touch panel formed of plural keys operated when an order for an article from a customer is received, is characterized by the step of displaying on the display unit a touch panel formed of keys corresponding to articles changed according to time slot.

According to the present invention, since a touch panel formed of keys corresponding to articles changed according to time slot is displayed on the display unit, the number of keys on the order entry screen can be reduced like the case described above. Hence, there is the advantage in that the screen visibility and the operator's operability can be greatly improved.

According to the present invention, the panel displaying method of an order receiving POS (Point-Of-Sales) terminal, wherein the POS terminal includes a display unit that displays a touch panel formed of plural keys operated when an order for an article from a customer is received, is characterized by the step of displaying on the display unit the information on a detailed statement of an article ordered by the customer when the customer pays for the article ordered, and displaying an enlarged display key to display enlargedly information regarding the detailed statement of the article on the display unit.

According to the present invention, information on a detailed statement of an article ordered by a customer can be displayed on the display unit when the customer pays for the article ordered, and an enlarged display key can be displayed to enlargedly display the detailed statement of the article on the display unit. Hence, before an article is handed over to a customer, an operator can confirm whether or not the prepared article agrees with the registered article by operating the enlarged display key at the spot remote from an order receiving POS terminal.

Moreover, according to the present invention, the panel displaying method of an order receiving POS (Point-Of-Sales) terminal, wherein the POS terminal includes a display unit that displays a touch panel formed of plural keys operated when an order for an article from a customer is received, is characterized by the step of displaying a touch panel having a memory key for temporarily holding order information before completion of a trade with the customer into a memory and a memory calling key for displaying the order information before the completion of a trade stored in the memory, on the display unit.

In this case, a screen to register an article is displayed on the display unit when the order information is information regarding that a customer's payment has been completed and a screen for the payment is displayed on the display unit when the order information is information regarding that a customer's payment has not been completed, when the order information before completion of the trade is read out by operating the memory calling key.

According to the present invention, even after or before payment, the operation can be quickly changed to another process, if necessary, by displaying a memory key and a memory calling key and then by operating them, while data is being held in the middle of the process. Hence, the operator's process can be smoothed advantageously.

According to the present invention, the order receiving POS terminal is characterized by a display for displaying a touch panel formed of plural keys operated when an order for an article from a customer is received, a memory for temporarily storing order information registered via the touch panel, and a control unit for controlling content of the memory and the display mode of the display according to operation of the touch panel, the touch panel forming the display unit including a memory key for temporarily storing the order information before completion of the customer's trade into the memory via the control unit, and a memory calling key for displaying the order information before completion of the trade stored in the memory.

In this case, the control unit erases the order information stored in the memory when the order information before completion of the trade is called out up by operation of the memory calling key.

The job of receiving an order for an article from a customer is formed of a registering process for registering the article ordered by the customer; and a paying process for paying for the article registered.

According to the present invention, the touch panel formed of keys each corresponding to an optional item upon an article registration can be pop-up displayed on the display unit. Hence, the pop-up-displayed touch panel can be operated without impairing the entire operational flow when the order receiving POS terminal is operated while the original screen image is left. The invention has the advantage of remarkably improving the operability as well as the serviceability to an operator.

According to the present invention, even after or before payment, the operation can be quickly changed to another process, if necessary, by displaying a memory key and a memory calling key and then operating them, while data is being held in the middle of the process. Hence, the operator's process can be smoothed advantageously.

Further, according to the present invention, the control unit can erase the order information stored in the memory when order information before trade completion is read out by the operation of a memory calling key. Hence, unnecessary data can be erased with no operator's special operation while the serviceability can be provided to operators without mistaking processed data for data in process.

### BRIEF DESCRIPTION OF THE DRAWINGS

FIG. 1 is a diagram showing an aspect of the display in an order receiving POS terminal according to an embodiment of the present invention;

FIG. 2 is a diagram showing an aspect of the display in an order receiving POS terminal according to an embodiment of the present invention;

FIG. 3 is a diagram showing an aspect of the display in an order receiving POS terminal according to an embodiment of the present invention;

FIG. 4 is a diagram showing an aspect of the display in an order receiving POS terminal according to an embodiment of the present invention;

FIG. 5 is a diagram showing an aspect of the display in an order receiving POS terminal according to an embodiment of the present invention;

FIG. 6 is a diagram showing an aspect of the display in an order receiving POS terminal according to an embodiment of the present invention;

FIG. 7 is a diagram showing an aspect of the display in an order receiving POS terminal according to an embodiment of the present invention;

FIG. 8 is a block diagram showing a POS system applied to an embodiment of the present invention;

FIG. 9 is a schematic perspective diagram showing an external appearance of an order receiving POS terminal applied to an embodiment of the present invention;

FIG. 10 is a block diagram showing the outline configuration of an order receiving POS terminal applied to an embodiment of the present invention;

FIG. 11 is a diagram showing an aspect of the display of an order receiving POS terminal according to an embodiment of the present invention;

FIG. 12 is a functional block diagram showing an order receiving POS terminal according to an embodiment of the present invention;

FIG. 13 is a functional block diagram showing in detail an order receiving POS terminal according to an embodiment of the present invention;

FIG. 14 is a diagram showing the screen configuration displayed on the display of an order receiving POS terminal according to an embodiment of the present invention;

FIG. 15 is a diagram showing the screen definition body according to an embodiment of the present invention;

FIG. 16 is a diagram showing the screen definition body according to an embodiment of the present invention;

FIG. 17 is a diagram showing the screen definition body according to an embodiment of the present invention;

FIG. 18 is a diagram showing the screen definition body according to an embodiment of the present invention;

FIG. 19 is a diagram showing a key definition body according to an embodiment of the present invention;

FIG. 20 is a flowchart used for explaining an embodiment of the present invention;

FIG. 21 is a flowchart used for explaining an embodiment of the present invention;

FIG. 22 is a flowchart used for explaining an embodiment of the present invention;

FIG. 23 is a flowchart used for explaining an embodiment of the present invention;

FIG. 24 is a flowchart used for explaining an embodiment of the present invention;

FIG. 25 is a diagram used for explaining the functional operation of the POS terminal according to an embodiment of the present invention;

FIG. 26 is a flowchart used for explaining the functional operation of the POS terminal according to an embodiment of the present invention;

FIG. 27 is a flowchart used for explaining the functional operation of the POS terminal according to an embodiment of the present invention; and

FIG. 28 is a schematic perspective diagram showing the external appearance of a general POS terminal.

### DESCRIPTION OF THE PREFERRED EMBODIMENTS

Let us explain an embodiment of the present invention with reference to the attached drawings.

(a) Explanation of the POS System Applied to the Present Embodiment:

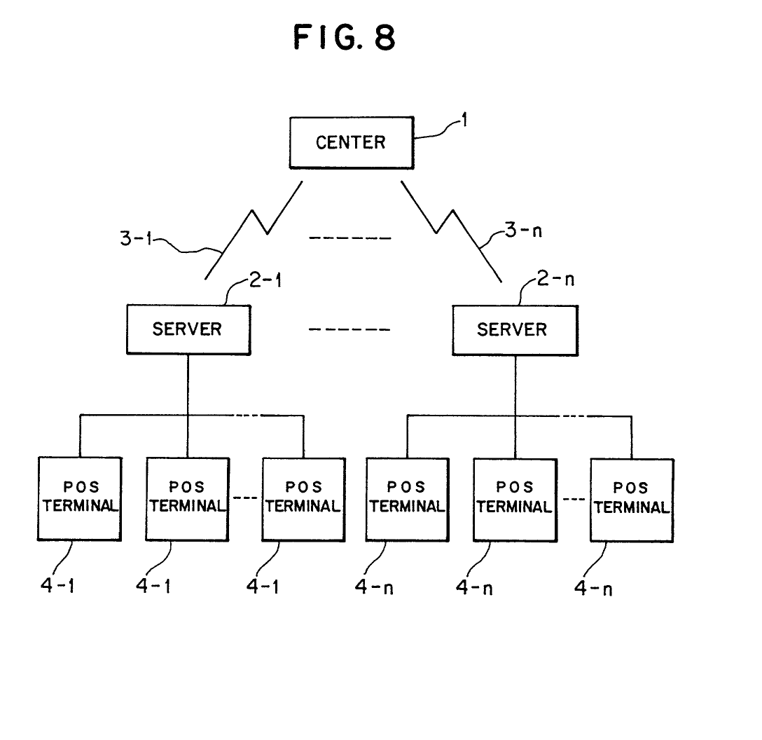

FIG. 8 is a block diagram showing a POS (Point-OF-Sales) system applied to an embodiment of the present invention. The POS system shown in FIG. 8 can be applied the management system in fast-food restaurants such as hamburger shops chained.

Numeral 1 represents a center. The center 1 manages comprehensively the whole of fast-food chains such as hamburger shops.

Numerals 2-1 to 2-n are servers. The servers 2-1 to 2-n are respectively arranged for chain stores forming fast-food restaurants to manage the stock of materials and sales and the like in each chain store.

Each of the servers 2-1 to 2-n in each restaurant accommodates plural POS terminals 4-1 to 4-n to receive orders for articles and is linked to the center 1 via the lines 3-1 to 3-n.

That is, the sales information and information on present stock amount in each chained restaurant managed by each of the servers 2-1 to 2-n are transferred to the center 1 via the lines 3-1 to 3-n. The center 1 can grasp sales or stock in each of chain stores and can arrange materials for each chain store.

Further, the POS terminals (order receiving POS terminals) 4-1 to 4-n are respectively arranged at, for example, the check-out counters in chain stores having the servers 2-1 to 2-n to accept orders for articles from customers.

Here, the order receiving job means that an operator operates the POS terminal (e.g. the POS terminal 4-1) to perform an article registering process which inputs (registers) articles ordered by customers and a payment process which completes payment for registered articles.

(b) Explanation of the Display Mode of the POS Terminal According to the Present Embodiment:

The display mode of the POS terminal according to the present embodiment will be described below as example of the POS terminal 4-1 accommodated in the server 2-1. However, other POS terminals 4-2 to 4-n have the same display mode respectively.

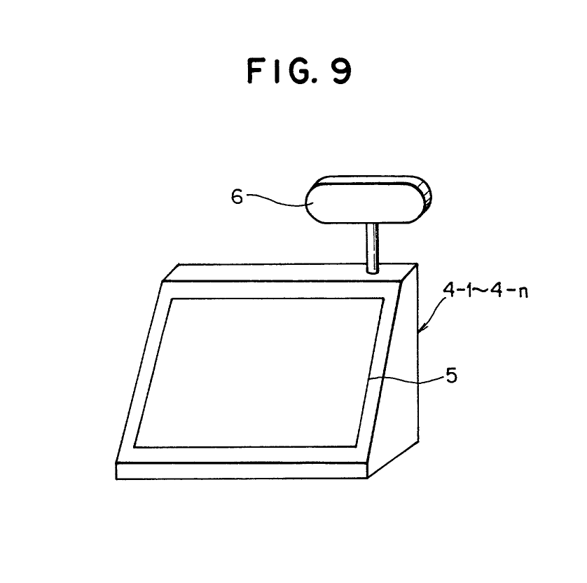

The POS terminal 4-1, as shown in FIG. 9, includes a display 5 acting as a displaying unit that displays a touch panel formed of plural keys operated (or touched with a finger) when the order from a customer is accepted. Numeral 6 represents a display for a customer that displays order information or the amount of paid money to a customer.

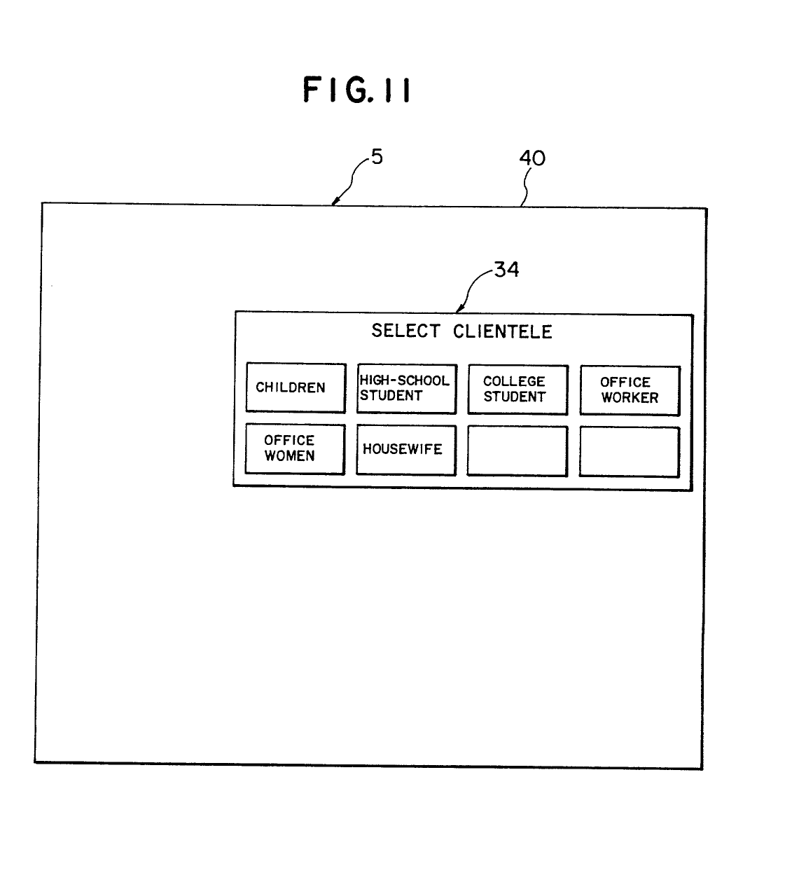

A touch sensor (refer to numeral 51 in FIG. 11) is attached on the top of the display 5 in the POS terminal 4-1 to detect an operator's procedure (that an operator touches a predetermined spot on the display screen by his finger). As described later, when an operator operates a predetermined screen position of the display 5, the POS terminal 4-1 operates according to the touch panel corresponding to the screen position.

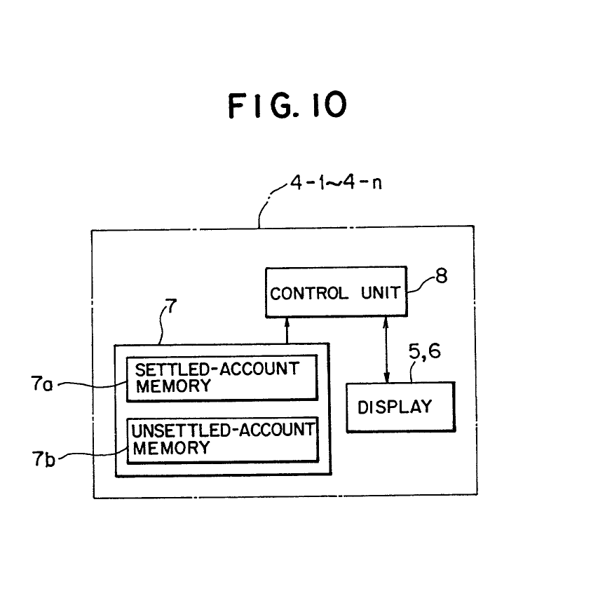

The POS terminal 4-1, as shown functionally in FIG. 10, includes the display 5, a display for a customer 6, a memory 7 that temporarily stores order information registered via the touch panel displayed on the display 5, and a control unit 8 that controls the content of the memory 7 and the display mode of the display 5 or 6 according to the operation of the touch panel.

The memory 7 is formed of a settled account memory 7a that holds information on an article for which payment has been completed and an unsettled account memory 7b that holds order information on accounts which has not yet been completed.

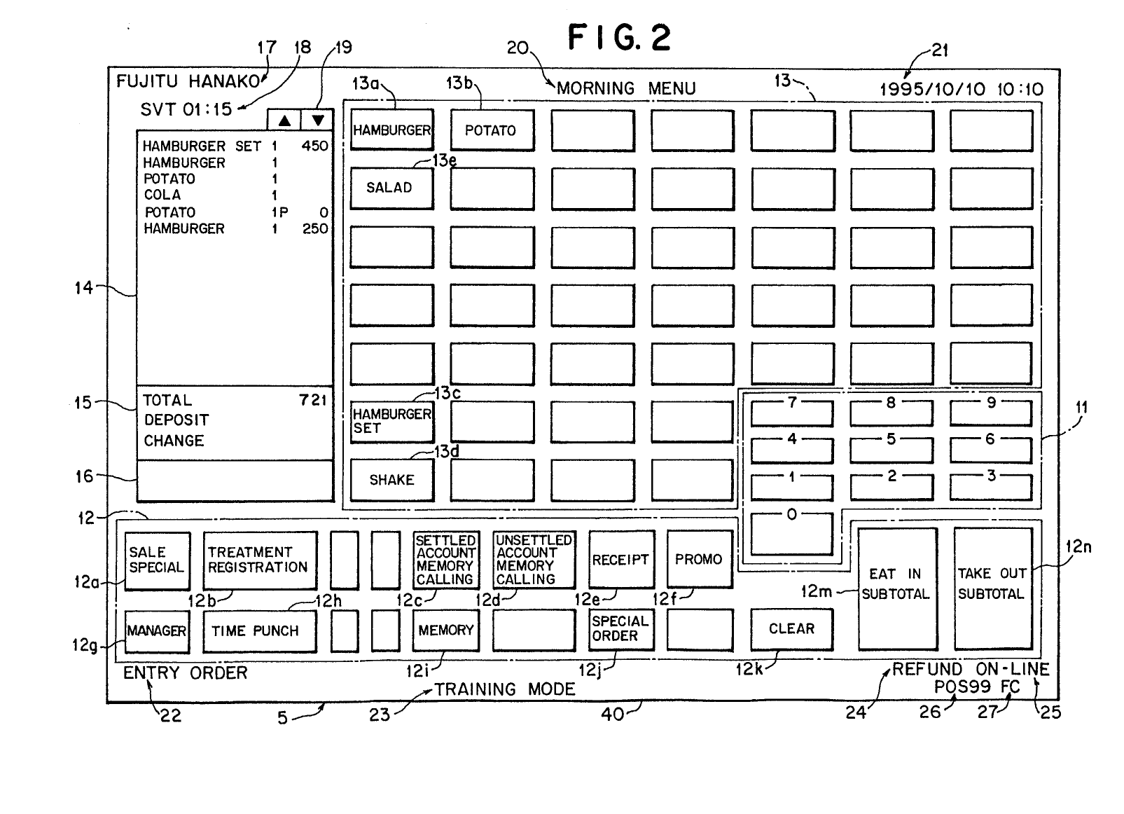

The display 5 of the POS terminal 4-1 displays as an order entry screen 40 a touch panel, e.g. shown in FIG. 2, formed of plural keys when an order for an article from a customer is accepted.

Numeral 11 represents a ten key unit which is operated when quantity is entered. Numeral 12 represents a function key unit formed of plural function keys by which various procedures are performed on the POS terminal 4-1. For example, the function key unit 12 consists of a sale special key 12a, a treatment registration key 12b, a settled-account-memory calling key 12c, an unsettled-account-memory calling key 12d, a receipt key 12e, a promo key 12f, a manager key 12g, a time-punch key 12h, a memory key 12i, a special order key 12j, a clear key 12k, an eat-in subtotal key 12m, a take-out subtotal key 12n, and the like.

Numeral 13 represents an item key unit formed of plural item keys operated upon article registration. The item key unit 13, for example, is formed of keys 13a, 13b and 13e each corresponding to one item shown next, a key 13c corresponding to a set article, or a key 13d for the same kind of articles.

For example, the keys 13a, 13b or 13e corresponds to one item such as “hamburger”, “potato” and “salad”. The key 13c corresponds to a set article such as “hamburger set” including “hamburger”, “potato” and “drink” selectable among plural kinds of articles. The key 13d serves as a category key showing a group article categorizing the same kind of articles such as “drinks” or “shakes”.

Further, article menus forming the item key unit 13 can be changed according to the time slot. Thus only the menu configuration currently used can be displayed in a restaurant where menus are changed according to time slot. In other words, the item key unit 13 functions as a touch panel formed of keys corresponding to articles changed according to time slots.

Numeral 14 represents a detail statement displaying unit displays statement, quantity and the amount of money regarding an order. Numeral 15 represents a sum displaying unit that displays the sum of money in the trade just before an account completion. Numeral 16 represents a quantity displaying unit that displays a figure input via the ten key unit 11.

Numeral 17 represents an operator displaying unit that displays the name of an operator which is registered when the POS terminal 4-1 begins to be used. Numeral 18 represents a serving time displaying unit that displays the time elapsed from a trade with a customer. Numeral 19 represents a scroll key that scrolls vertically the statement displaying unit 14.

Numeral 20 represents a panel name displaying unit that displays the name of a panel currently displayed (or “morning menu” since the panel of a morning menu is displayed in FIG. 2). Further, numeral 21 represents a date and time displaying unit that displays a current date and time (or “Oct. 10, 1995 10:10” in FIG. 2).

Numeral 22 represents a message displaying unit that displays a guidance message regarding an error message or procedure (or “entry order” in FIG. 2). Numeral 23 represents a training mode displaying unit that displays “training mode” when the POS terminal 4-1 is operating in a training mode.

Moreover, numeral 24 represents a process mode processing unit that displays any one of modes in process (e.g. “cancellation”, “refund” and “division”) (or “refund” displayed in FIG. 2). Numeral 25 represents a connection state displaying unit that displays “ON-LINE” when the POS terminal 4-1 is connected to the server 2-1 and “OFF-LINE” when the POS terminal 4-1 is not connected to the server 2-1 (or “ON-LINE” in FIG. 2).

Numeral 26 represents a POS number displaying unit that displays the number of POS terminal 4-1 in use (or “POS99” in FIG. 2). Numeral 27 represents a POS mode displaying unit that displays the mode of the POS terminal 4-1 in use. For example, “FC” is displayed for the POS terminal which receives order at the counter in a restaurant while “DT” is displayed for the POS terminal which receives the order in a drive-through manner.

In such an arrangement, an operator can accept order from a customer by operating the control panel displayed (panel-displayed) on the display 5 of the POS terminal 4-1, as shown in FIG. 2, and performs various procedures by means of the function key unit 12 (to be described later).

That is, an operator performs menu entries (entry of an article and the quantity thereof ordered by a customer; article registering procedure by touching his finger to the item key unit 13 and the ten key unit 11 in the control panel. The statement displaying unit 14 displays data (article name, quantity, and the amount of money) on articles registered using the item key unit 13 and the ten key unit 11.

When a customer orders, for example, “hamburger set”, an operator operates the key 13a corresponding to “hamburger set” in the item key unit 13 displayed on the display 5.

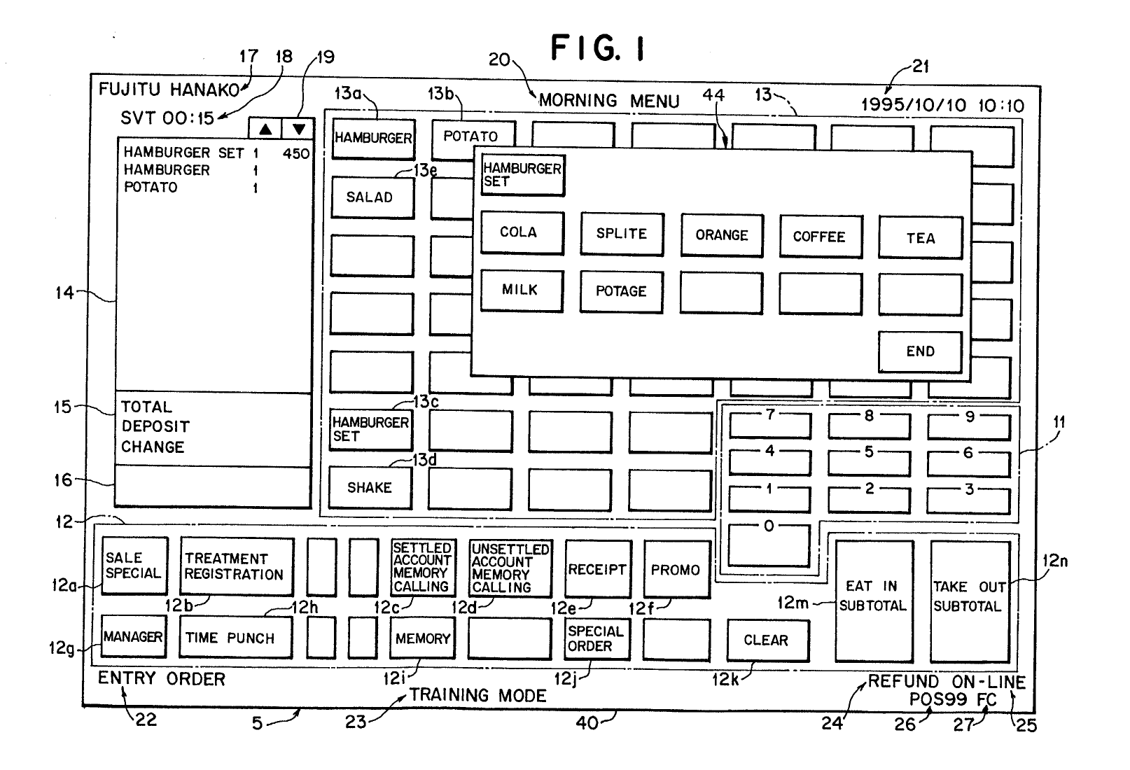

Thus, “hamburger” and “potato” are displayed on the statement displaying unit 14 in the display 5, as shown in FIG. 1. As for “drinks”, the touch panel 44 formed of keys corresponding to optional drinks is pop-up displayed as a sub-screen.

In other words, when a set article in which plural items are combined such as the “hamburger set” is ordered, items (basic articles) treated as basic items in the set article are displayed as registered articles on the display 5. As for optional items such as “drinks” other than the basic items in the set article, the touch panel 44 formed of keys corresponding to optional items is pop-up displayed on the display 5.

In this case, the touch panel 44 formed of keys corresponding to “Cola”, “Splite (trade name)”, “Orange”, “Coffee”, “Tea”, “Milk” and “Potage”, together with the “selection end key” for completing the selecting operation, is pop-up displayed for “drink” included in “hamburger set”. An operator can register drinks by operating keys corresponding to respective items in response to a customer's order.

When a desired number of optional drinks, except the above-mentioned basic items, are selectively registered, the pop-up display of the touch panel 44 is released.

When a customer, for example, orders “strawberry shake M”, an operator operates the key 13d corresponding to “shake” in the item key unit 13 displayed on the display 5.

Further, when the key 13d as a category key is operated, the touch panel 45 formed of keys corresponding to the kind of item (“shake”) belonging to the key 13d is pop-up displayed (or sub-screen displyed) as an article table on the display 5.

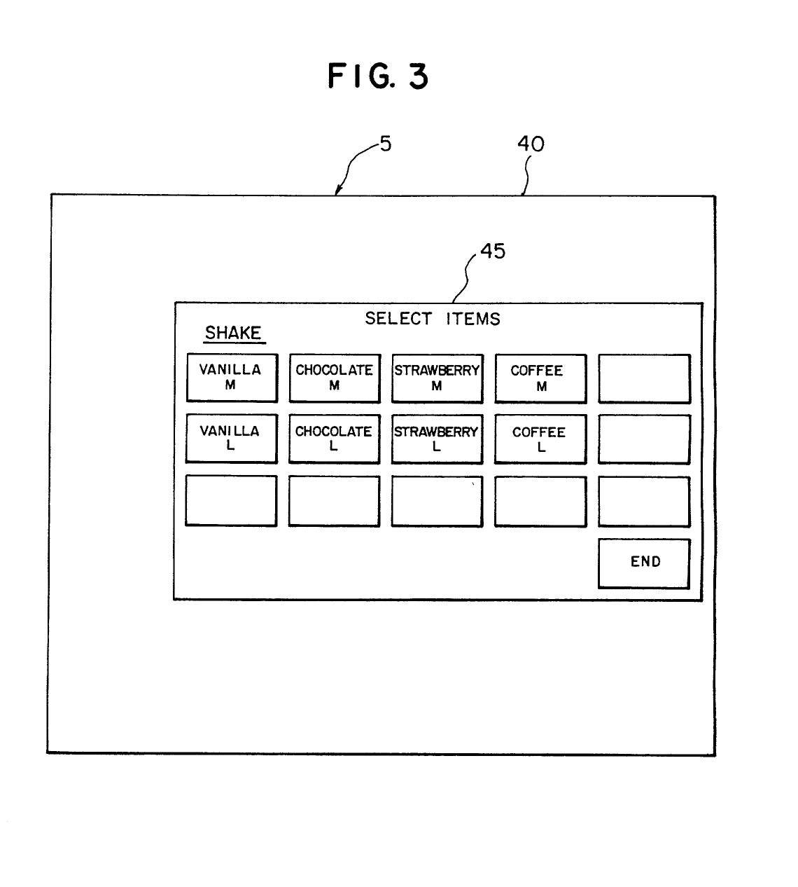

That is, the touch panel 45 formed of keys (for “vanilla MI, “vanilla L”, “chocolate M”, “chocolate L”, strawberry M”, “strawberry L”, “coffee M”, and “coffee L”) corresponding to optional kinds of “shakes” is pop-up displayed on the display 5, for example, as shown in FIG. 3.

Thereafter, when an operator operates the key corresponding to “strawberry shake M” on the touch panel 45 shown in FIG. 3, the “strawberry shake M” is displayed as a registered article on the detail statement displaying unit 14.

In other words, the article groups categorized into the same kinds are items selectable by operating the category key. The touch panel formed of keys corresponding to article groups categorized in the same kinds of items are pop-up displayed (or sub-screen displayed) on the display 5.

For some articles, any one of seasoning (condiment articles) can be chosen. For example, when a customer orders “salad”, he or she can choose “dressing” optionally. Like the case shown in FIGS. 1 and 3, condiment articles such as “dressing” can be selected with the touch panel pop-up displayed.

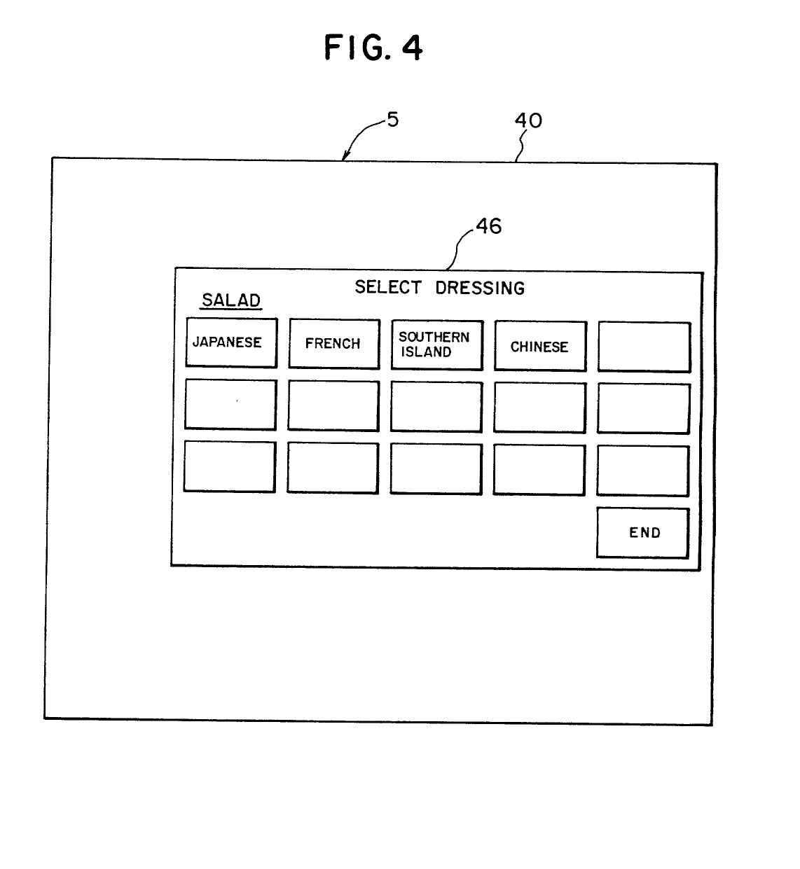

In that case, when an operator registers “salad” by operating the key 13e, the touch panel 46 is pop-up displayed on the display 5 to select “dressing” as a condiment article shown in FIG. 4.

In such an operation, an optional item can be registered via the touch panel 44 or 45 while an optional item such as “dressing” not reflected to sales are registered via the touch panel 46. Thus the procedure can be treated as a piece of management data in the center 1.

In other words, the touch panel 46 formed of keys corresponding to the condiment articles can pop-up display (or sub-screen display) the condiment article as an optional item on the display 5 upon receiving orders for articles.

The sale special key 12a in the function key unit 12 is used for a sale special operation. The operator registration key 12b is used to register an operator.

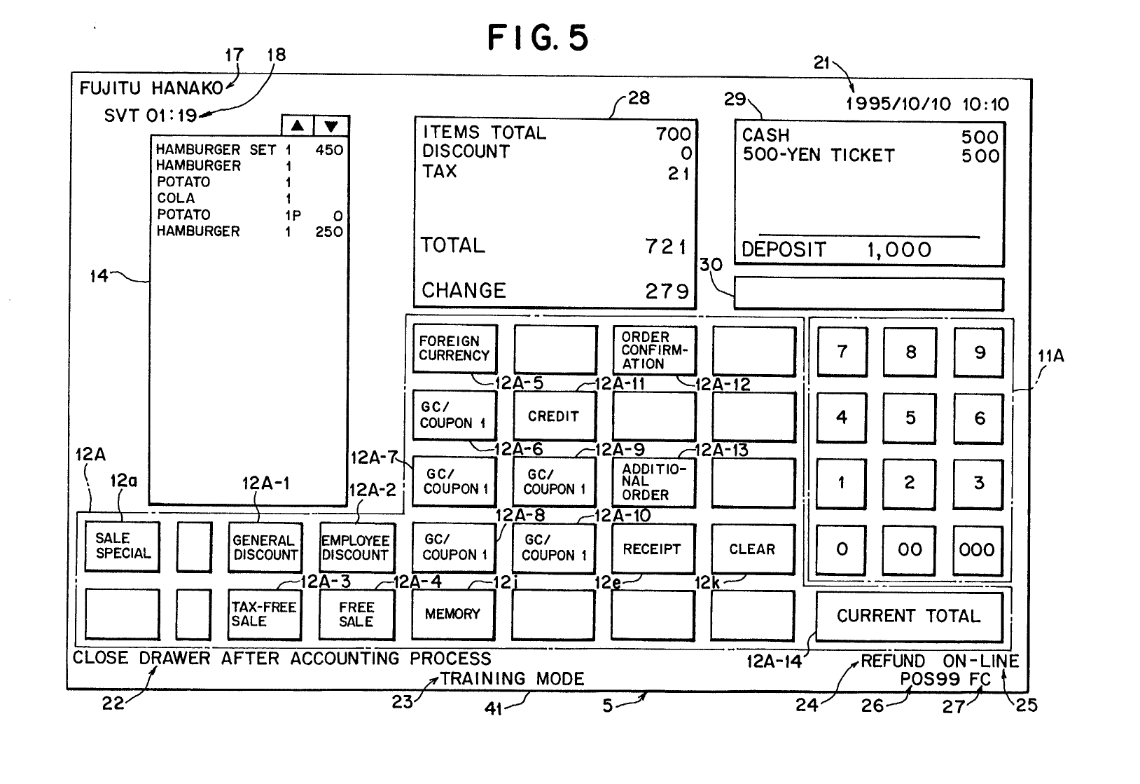

The eat-in subtotal key 12m is used to add up an eat-in trade (eating and drinking in shop). The take-out subtotal key 12n is used to add up a take-out trade (taking out of shop). When the subtotal key 12m or 12n is used, the display 5 shifts the order entry screen 40 displayed on the panel upon receiving a customer's article-order as shown in FIGS. 1 and 2 to the account screen 41 (to be shown in FIG. 5 later).

The memory key 12i is used to store the displayed order (order information) into the memory 7. When the payment of the order displayed in the operation of the memory key 12i has been completed, the order is stored in the settled account memory 7a. When the payment has not been completed, the order is stored in the unsettled account memory 7b.

For example, when an operator who operates the POS terminal 4-1 has received money due from a customer, if ordered articles are not prepared, the order information is stored into the settled account memory 7a by operating the memory key 12i. Thereafter, when the ordered article is prepared, the operator can collate the prepared article with the order information before handing over them to the customer by calling the content out of the settled account memory 7a.

Further, when an operator who operates the POS terminal 4-1 executes another process before receiving money due from a customer, the order information can be stored into the unsettled account memory 7b by operating the memory key 12i. Thereafter, the operator can perform another procedure.

In such procedure, particularly, even if a customer wants to withhold payment until an article is prepared, the operator can deal with orders from customers lining behind till the article is prepared.

When a customer stops ordering on the way to ordering items, an operator operates the memory key 12i to store temporarily the order information into the unsettled account memory 7b, thus accepting orders from customers lining behind without delay. In this case, after there are no customers waiting for orders, the order information is called up through the operation of the unsettled account memory calling key 12d. Then the order information can be canceled by means of the sale special key 12a.

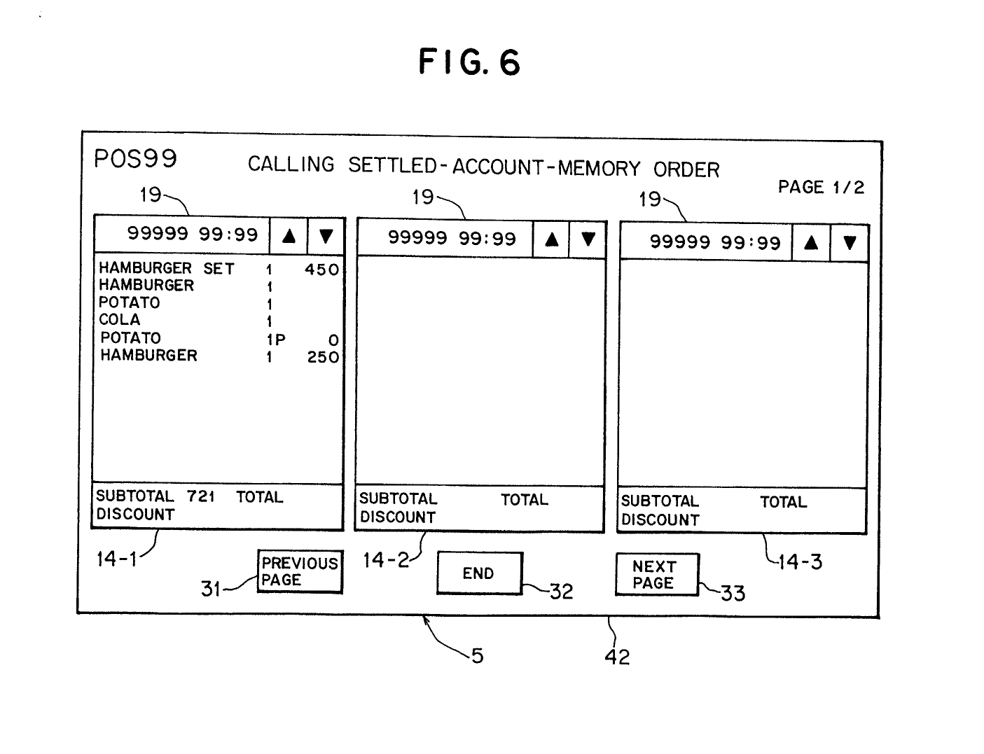

Further, the settled account memory calling key 12c is used to display the settled account order stored in the settled account memory 7a on the order entry screen 40 shown in FIG. 2. When the settled account memory calling key 12c is operated, a screen 42 is displayed to select a desired piece of order information among plural kinds of order information stored in the settled account memory 7a (to be shown later in FIG. 6).

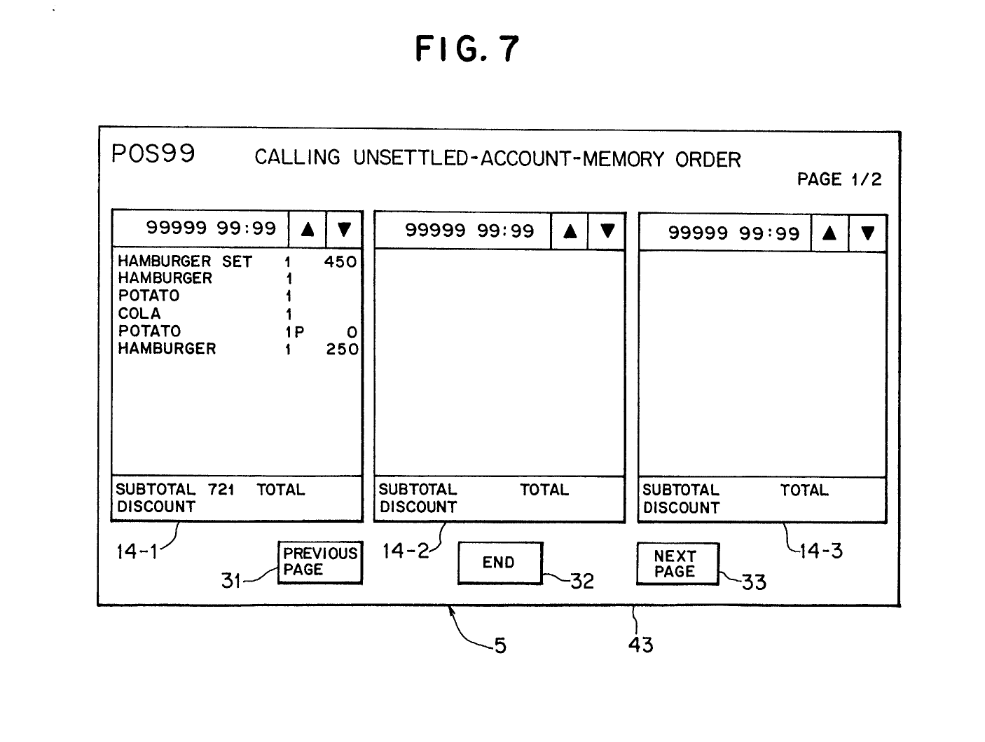

The unsettled account memory calling key 12d is used to display the unsettled account order stored in the unsettled account memory 7b on the account screen 41 shown in FIG. 5. When the unsettled account memory calling key 12d is operated, a screen 43 is displayed to select a desired piece of order information among plural kinds of order information stored in the unsettled account memory 7b (to be shown in FIG. 7 later).

Hence, the memory key 12i functions as a memory key that temporarily stores order information before completion of an order with a customer (when an article is not exchanged for money) into the memory 7 via the control unit 8. The settled account memory calling key 12c and the unsettled account memory calling key 12d function as a memory calling key that displays order information before completion of a trade stored in the memory 7.

When the order information prior to completing a trade is called out by operating the memory calling keys 12c and 12d, the control unit 8 erases the order information held in the memory 7.

The special order key 12j is used to input a special order such as “hamburger with no pickles”. In this case, when an operator touches his finger to the special order key 12j, the touch panel is pop-up displayed to select the content of a special order, like the case shown in FIG. 1, 3 or 4. The pop-up display permits a desired special order.

In other words, in order to select the special order contents as optional items when an article order is received, the touch panel formed of keys corresponding to special order contents can be pop-up displayed (or sub-screen displayed) on the display 5.

The receipt key 12e is used to issue receipts. The promo key 12f is used to input a free promo. The manager key 12g is used to perform a POS manager job. The job starting and ending key 12h is used to register job starting and ending. The clear key 12k is used to invalidate figures displayed on the quantity displaying unit 16, free marks, or information on clientele input lately.

As described above, when the subtotal key 12m or 12n is operated, the display 5 displays the account screen 41 as shown in FIG. 5. In FIG. 5 and FIGS. 1 and 2, like numerals represent like elements.

In the account screen 41 shown in FIG. 5, numeral 11A represents a ten key unit used when deposit money or the number of coupons is input. The value input via the ten key unit 11A is displayed on the input value displaying unit 30.

Numeral 12A is a function key unit. The function key unit 12A is used when various procedures are performed at the POS terminal 4-1.

Further, like the function key unit 12 shown in FIGS. 1 and 2, the function key unit 12A includes a sale special key 12a, a receipt key 12e, a memory key 12i, a clear key 12k, a general discount key 12A-1, an employee discount key 12A-2, a tax-free discount key 12A-3, a free sale key 12A-4, a foreign currency key 12A-5, GC/coupon keys 12A-6 to 12A-10 corresponding to kinds of GC/coupons, a credit key 12A-11, an order confirmation key 12A-12, an additional order key 12A-13 and a total key 12A-14 used when a calculation is made in a trade.

Numeral 28 represents a sum displaying unit that displays a subtotal of items in a trade, the sum of discount values, taxes, the total money and changes. Numeral 29 represents a deposit money type and sum displaying unit that displays the type of deposit money and the sum corresponding to cash or coupon deposited from a customer input from the ten key unit 11A or GC/coupon keys 12A-6 to 12A-10.

Further, the order confirmation key 12A-12 is operated when an operator particularly wants an enlarged clear view of the detail statement displaying unit 14, for example, upon picking items (when items are prepared from an article counter remote from the POS terminal 4-1), and functions as an enlarged display key.

That is, when payment is made for items ordered by a customer, the detail statement displaying unit 14 displays detail statement information on them. An operator can enlarge the display on the detail statement displaying unit 14 by operating the order confirmation key 12A-12 so that the display content of the detail statement displaying unit 14 can be collated even at places remote from the POS terminal 4-1.

As described above, when an operator operates the settled account memory calling key 12c on the order entry screen 40 shown in FIG. 2, a screen 42 can be displayed to select a desired piece of order information among plural kinds of settled account order information on the display 5, as shown in FIG. 6. In FIG. 6 and FIGS. 1 and 2, like numerals represent like elements.

In the screen 42 used to select the order information shown in FIG. 6, three kinds of order information are displayed on order displaying units 14-1 to 14-3.

Each of the order displaying units 14-1 to 14-3 functions as a key that selects order information used in the order calling operation. For example, when the order displaying unit 14-1 is operated (by touching with a finger), the order information displayed on the order displaying unit 14-1 is called out.

Numeral 31 represents a previous page key used when the order information on the previous page with respect to the current screen is displayed. Numeral 33 represents a next page key used when the order information on the next page with respect to the current screen is displayed. Numeral 32 represents an end key used when the current screen returns to the order entry screen 40.

As described above, when an operator operates the unsettled account memory calling key 12d on the order entry screen 40 shown in FIG. 2, the display 5, as shown in FIG. 7, displays a screen 43 to select a desired piece of order information among plural kinds of unsettled account order information. In FIG. 7 and FIG. 6, like numerals represents like elements.

When an operator waits on customers using the POS terminals 4-1 to 4-n, the touch panel 34, for example, as shown in FIG. 11 formed of plural keys to input the article ordering clientele can be pop-up displayed on the order entry screen 40, preceding the job of receiving orders for items from the customers.

(c) Explanation of the Functional Configuration of the POS Terminal According to the Present Embodiment:

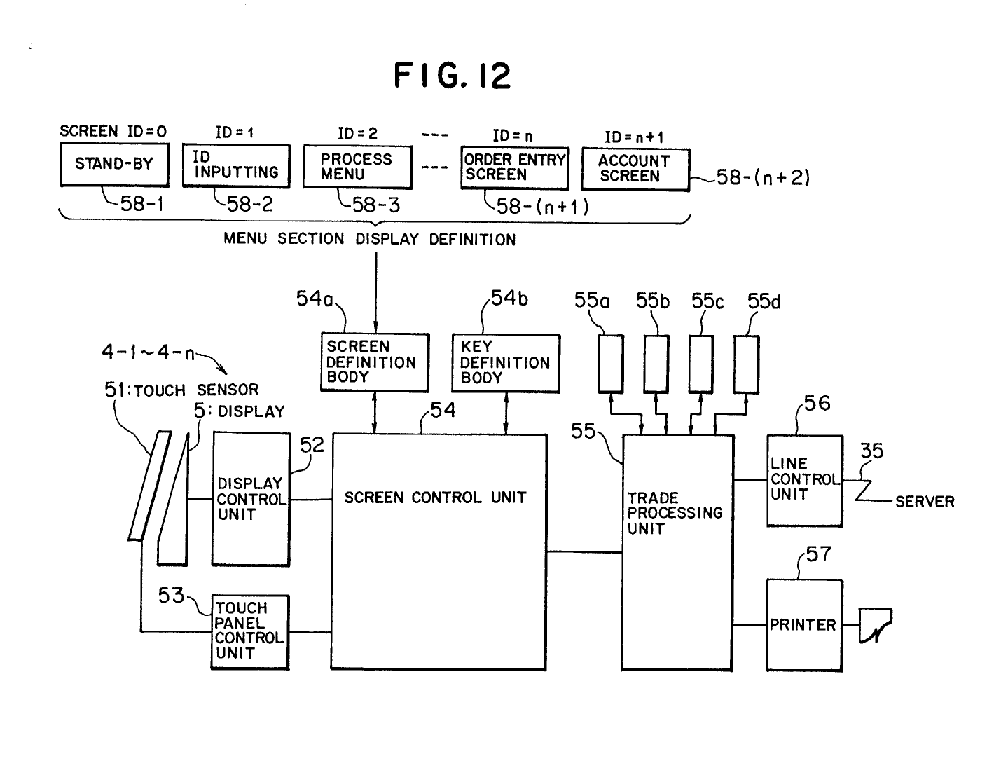

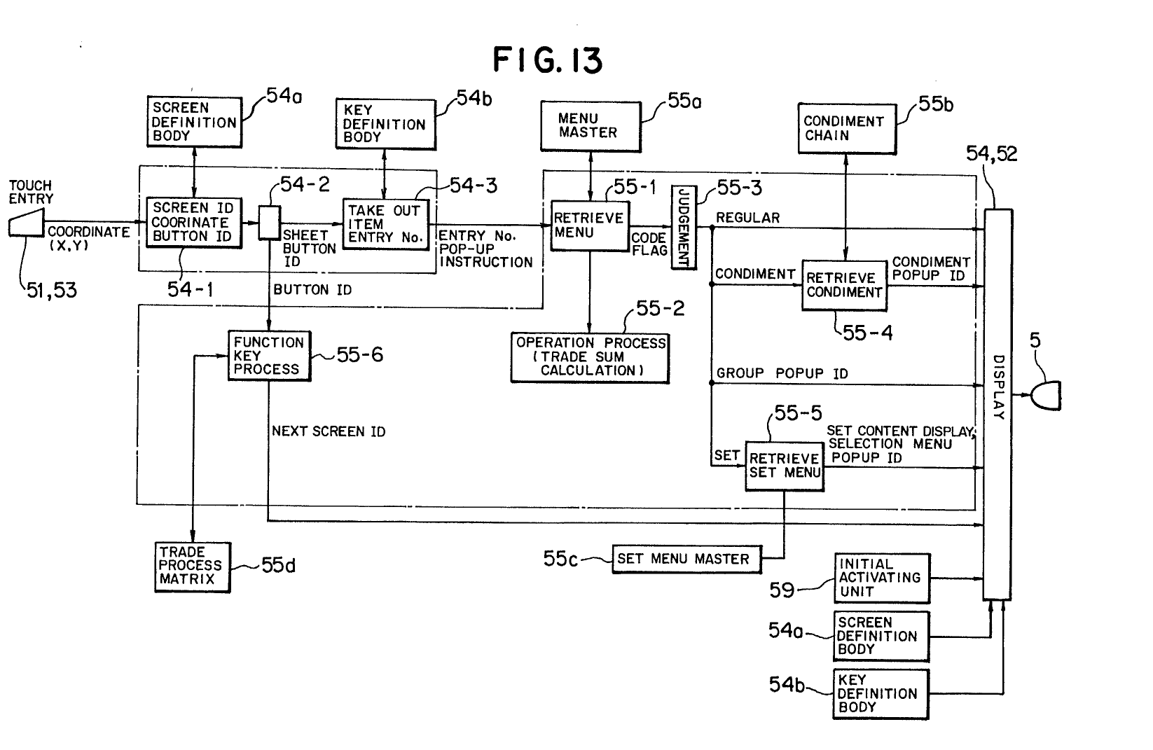

The POS terminals 4-1 to 4-n have functionally the configuration shown in FIG. 12 and have in more detail the configuration shown in FIG. 13. That is, each of the POS terminals 4-1 to 4-n consists of the above-mentioned display 5, a touch sensor 51, a display control unit 52, a touch panel control unit 53, a screen control unit 54, a screen definition body 54a, a key definition body 54b, a trade processing unit 55, a menu master 55a, a condiment chain 55b, a set menu master 55c, a trade processing matrix 55d, a line control unit 56, and a printer 57.

The display control unit 52, the touch panel control unit 53, the screen control unit 54, the trade processing unit 55 and the line control unit 56 can be formed of the control unit 8 shown in FIG. 10. The screen definition body 54a, the key definition body 54b, the menu master 55a, the condiment chain 55b, the set menu master 55c, and the trade processing matrix 55d can be formed of the memory 7.

The touch sensor 51 detects an operator's operation over the screen of the display 5. For example, resistance films, electrostatic capacitance, infrared rays or ultrasonic waves are used for the touch sensor 51.

The display control unit 52 performs display-control to display the contents to be displayed next on the display 5 according to the instructions from the screen control unit 54. By judging the position on the display 5 touched by an operator with coordinate values (x, y), based on detection information from the touch sensor 51, the touch panel control unit 53 outputs it to the screen control unit 54.

The screen definition body 54a defines and holds plural screen patterns displayed in the POS terminals 4-1 to 4-n by adding ID (Identification) numbers to them.

Further, the key definition body 54b defines an item code relative value and a necessary sub-screen (pop-up screen) ID to respective buttons in the item key unit 13 shown in FIGS. 1 and 2.

The screen control unit 54 receives the position information (x, y coordinate values) on the display 5 operated by an operator from the touch panel control unit 53 and then decides the position where the position information is displayed on the screen by referring to the screen definition body 54a and the key definition body 54b. The screen control unit 54 also creates display data according to the instruction from the trade processing unit 55 (to be described later) to ask the display control unit 52 of displaying it on the display 5.

In response to the screen operation information on an operator's item registration from the screen control unit 54, the trade processing unit 55 takes data for display regarding trades with customers out of the menu master 55a, the condiment chain 55b, the set menu master 55c and the trade processing matrix 55d.

The line control unit 56 interfaces the line 35 connecting the POS terminals 4-1 to 4-n with the servers 2-1 to 2-n on the side of the POS terminals 4-1 to 4-n. The trade information output from the trade processing unit 55 is transmitted to the servers 2-1 to 2-n via the line control unit 56 and the line 35.

The printer 57 prints as a receipt detail statement information on a trade with a customer.

The screen definition body 54a, as shown in FIG. 12, holds information regarding the screens 58-1 to 58-(n+2) of plural patterns (e.g. n+2 pattern; ID=“0” to “n+2”) with ID (Identification) numbers. The display 5 can arbitrarily display the screens 58-1 to 58-(n+2) corresponding to patterns held in the screen definition body 54a.

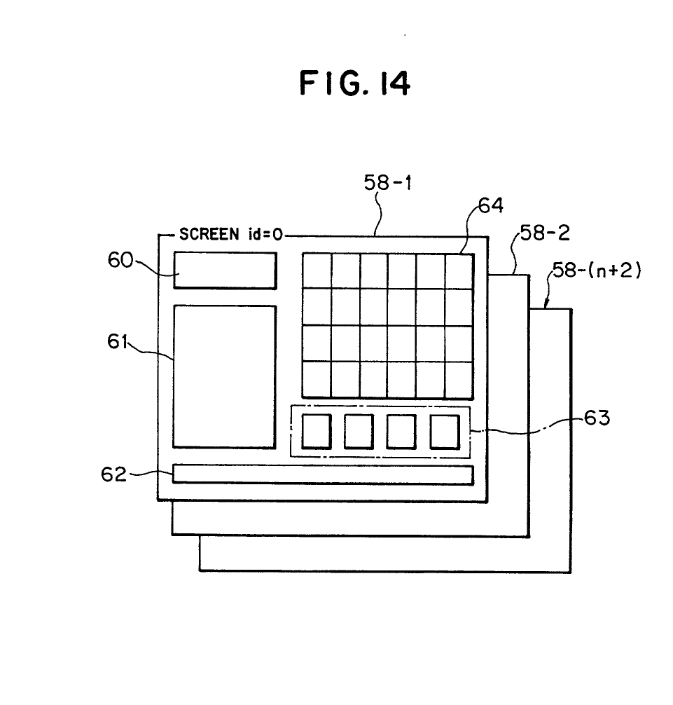

As shown in FIG. 14, each of the screens 58-1 to 58-(n+2) corresponding to patterns defined by the screen definition body 54a is formed of a text unit 60 that displays character rows, a list unit 62 that displays a large number of character rows such as error messages, a button unit 63 that displays the screen including buttons and is button-input when the screen is touched, a sheet button unit 64 including plural buttons arranged in a menu sheet form, and a sheet text unit 61 that displays character rows according to the operation of the sheet button unit 64.

For example, in the order entry screen 40 shown in FIGS. 1 and 2, the text unit 60 is formed of the operator displaying unit 17 and the serving time displaying unit 18. The sheet text unit 61 is formed of the detail statement displaying unit 14, the sum displaying unit 15 and the quantity displaying unit 16.

Further, the list unit 62 is formed of a message displaying unit 22, a training mode displaying unit 23, a process mode processing unit 24, a connection state displaying unit 25, and POS number displaying units 26 and 27. The button unit 63 is formed of a function key unit 12 or 12A. The sheet button unit 64 is formed of an item key unit 13, and a ten key unit 11 or 11A.

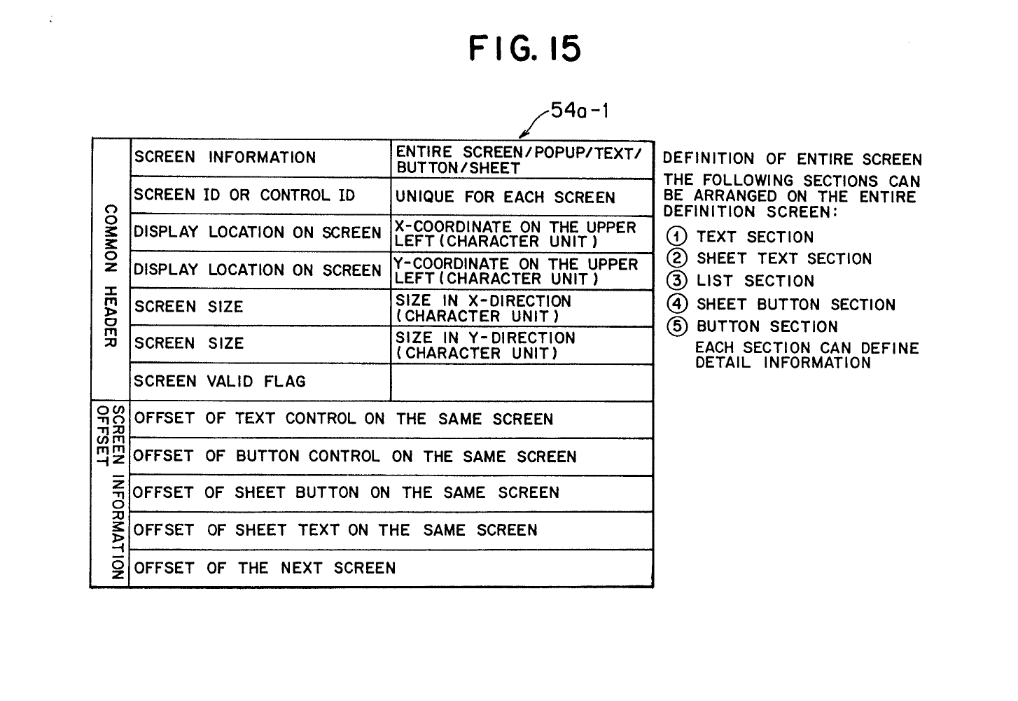

Further, the screen definition body 54a holds and defines the details of the screen pattern corresponding to each screen ID, as shown in FIGS. 15 to 18.

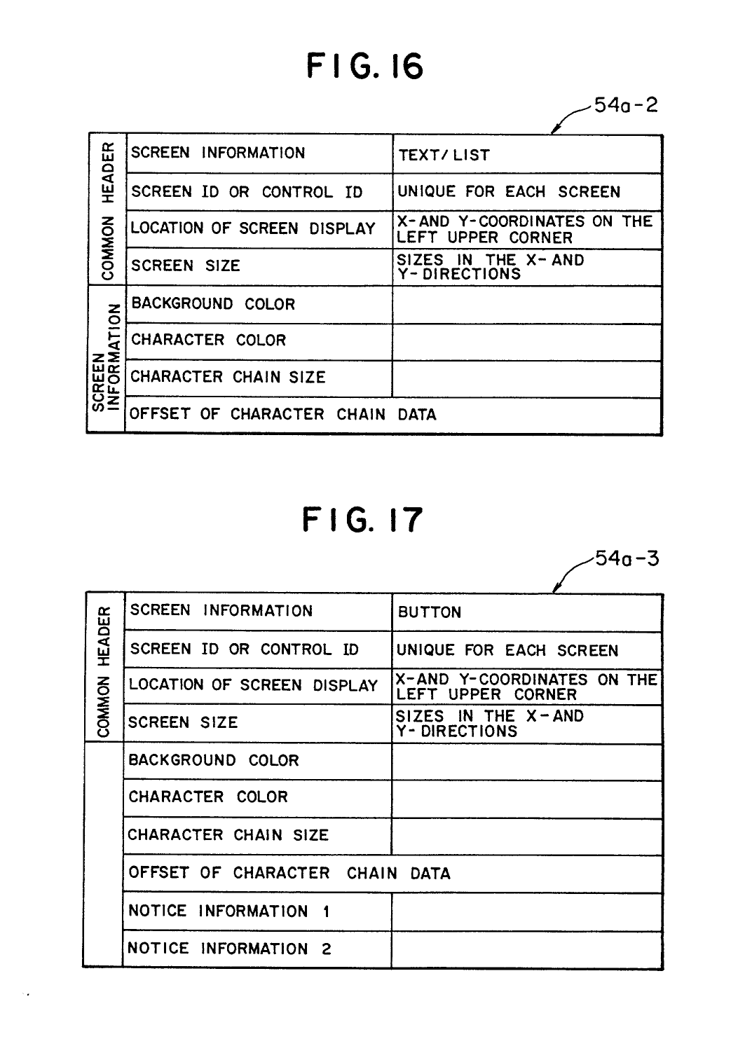

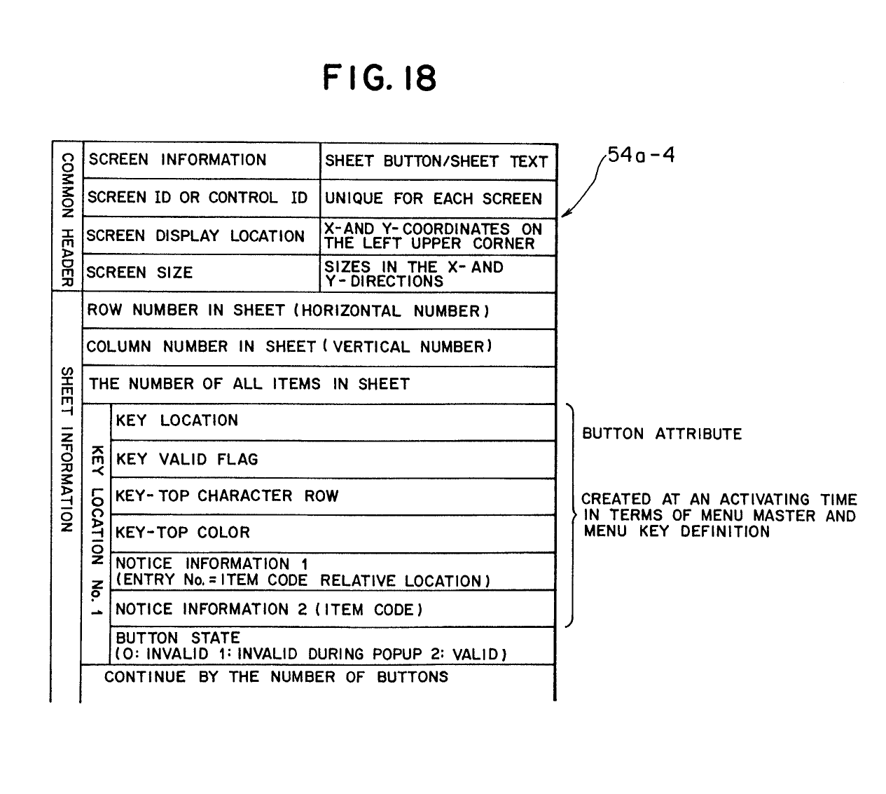

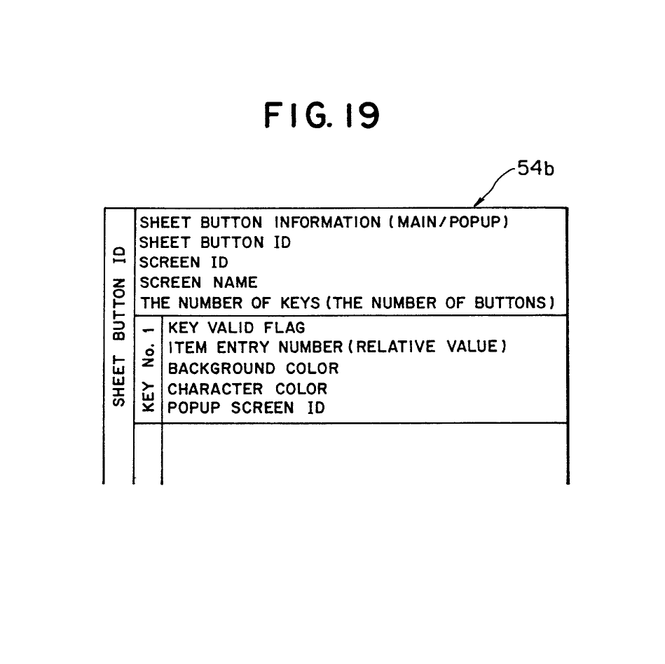

That is, the screen definition body 54a is formed of an entire definition screen definition body 54a-1 shown in FIG. 15, a text/list screen definition body 54a-2 shown in FIG. 16, a button screen definition body 54a-3 shown in FIG. 17, and a sheet button/sheet text screen definition body 54a-4 shown in FIG. 18.

The entire definition screen definition body 54a-1 holds and defines information regarding the entire screen including the screen of a touch panel pop-up-displayed for each screen ID, for example, as shown in FIG. 15. That is, as shown in FIG. 15, the position of the entire screen display, the size of the entire screen, the screen valid flag, and the like are held and defined as a common header while screen information offset is held and defined.

The text/list screen definition body 54a-2 holds and defines control information on the text unit 60 and the list unit 62, for example, as shown in FIG. 16. That is, as shown in FIG. 16, information regarding the positions where the text unit 60 and the list unit 62 are displayed and the sizes thereof is held and defined as a common header. The background color, the color of characters, size of character row, offset of character row data and the like are held and defined as detail information.

Similarly, the button screen definition body 54a-3 holds and defines the control information of the button unit 63, for example, as shown in FIG. 17. That is, as shown in FIG. 17, the position where the button unit 63 is displayed and the size thereof are held and defined as a common header. The background color, the color of a character row, the size of a character row, the offset of character row data, notice information, and the like are held and defined.

Further, the sheet button/sheet text screen definition body 54a-4 holds and defines the control information regarding the sheet button unit 64 and the sheet text unit 61, for example, as shown in FIG. 18. That is, as shown in FIG. 18, the position where the sheet button unit 64 is displayed and the size thereof are held and defined as a common header. Information on the number of rows and the number of columns in a sheet and the number of all items and information on a button attribute, and a button state are held and defined as information held and defined for each button.

The information regarding a button attribute can be formed of the key position for each button, a key valid flag showing whether or not the key is valid, a key-top character row, a key-top color, and notice information. The information regarding the button attribute of the screen definition body 54a is integrated from the key definition body 54b and the menu master 55a (to be described later) when the initial activating unit 59 (refer to FIG. 13) in each of the POS terminals 4-1 to 4-n is activated.

The key definition body 54b defines the item code relative value and the necessary sub-screen (pop-up screen) ID for each button defined in the sheet button unit 64. For example, the key definition body 54b has a configuration shown in FIG. 19.

That is, the key definition body 54b defines sheet button information (main screen/pop-up screen), sheet button ID, screen ID, screen name and the number of keys (the number of buttons). The key valid flag, item entry number (relative value), background color, character color and pop-up screen ID and the like are defined and held for each button defined by the sheet button unit 64.

The screen control unit 54, as shown in detail in FIG. 13, includes an ID retrieving unit 54-1, an ID judging unit 54-2 and an item entry number extracting unit 54-3.

The ID retrieving unit 54-1 detects the key (button) position on the corresponding screen, based on the position information (x, y coordinate value) from the touch panel control unit 53, while referring to the screen definition body 54a. The retrieved result is output as key identification information (key ID information). That is, the ID detecting unit 54-1 detects the key (button) on a screen displayed operated by an operator, based on the key identification information.

Further, the ID deciding unit 54-2 decides the key identification information input from the ID detecting unit 54-1. In concrete, when key identification information corresponds to a key in the sheet button unit 64, the sheet button ID is output as the key identification information to the item entry number extracting unit 54-3. At the same time, when key identification information corresponds to a key in the button unit 63, the button ID is output to the function key processing unit 55-6 in the trade processing unit 55 (to be described later) as the key identification information.

The item entry number taking unit 54-3 reads out an item entry number by referring to the key definition body 54b, based on the sheet button ID input from the ID deciding unit 54-2 and then outputs it to the trade processing unit 55. When the key corresponding to the sheet button ID must be pop-up displayed, the trade processing unit 55 receives the fact as a report.

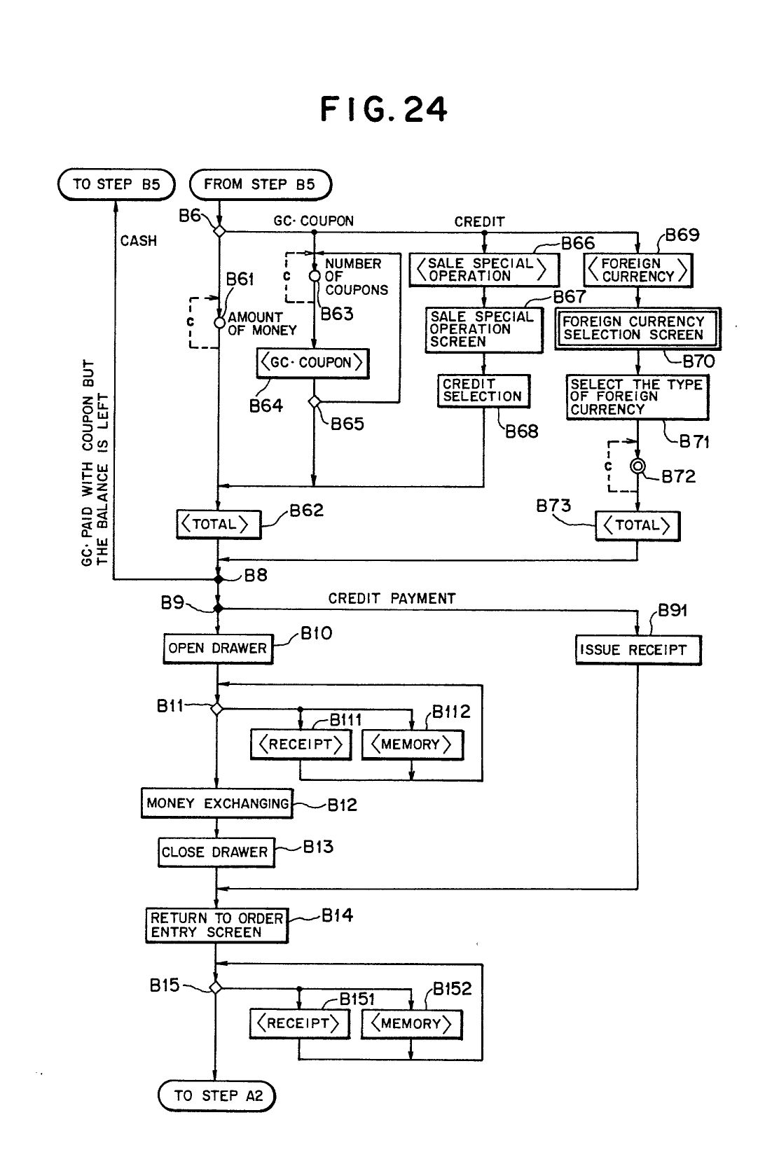

The menu master 55a holds flags each showing the item code, item name, unit price and type of each item corresponding to an item entry number. The menu master 55a has the detail configuration shown in FIG. 24 (to be described later).

Further, the condiment chain 55b stores a menu for optional condiment articles. The set menu master 55c stores the name of an item as a basic constituent element and an optional menu in each set article.

The trade processing matrix 55d functions as a table in which button IDs are input as key identification information from the ID deciding unit 54-2 and which holds the screen ID to be displayed next corresponding to the button ID.

Thus, the trade processing unit 55 reads the name, price, or the like of each item corresponding to an item entry number input from the screen control unit 54 by referring to the menu master 55a and then calculates payment for an article ordered by a customer. The trade processing unit 55 can also read out the optional menu of a set article, a group menu, or a condiment article menu by referring to the condiment chain 55b, the set menu master 55c and the trade process matrix 55d.

The trade processing unit 55, as shown in detail in FIG. 13, consists of a menu retrieving unit 55-1, an arithmetic operating unit 55-2, a deciding unit 55-3, a condiment retrieving unit 55-4, a set menu retrieving unit 55-5 and a function key processing unit 55-6.

That is, the menu retrieving unit 55-1 receives an item entry number and a necessary pop-up instruction from the item entry number extracting unit 54-3 in the screen processing unit 54 and then reads out a flag showing the item code, item name, unit price, and item type of each article corresponding to an item entry number over referring to the menu master 55a. The arithmetic operating unit 55-2 works out the sum of a trade based on the price of each article taken out of the menu retrieving unit 55-1.

Further, the deciding unit 55-3 decides the next process based on a flag showing an item code and an item type retrieved by the menu retrieving unit 55-1.

In concrete, when the item code retrieved by the menu retrieving unit 55-1 shows a regular article with no optional items, the deciding unit 55-3 outputs the item code to the screen control unit 54 and then displays it on the display 5 via the display control unit 52 in a regular display mode.

When the item code retrieved by the menu retrieving unit 55-1 shows an article with optional condiment items, the deciding unit 55-3 outputs the item code to the condiment retrieving unit 55-4 and then displays a touch panel to select a condiment article.

Further, when the item code retrieved by the menu retrieving unit 55-1 shows a group item, the deciding unit 55-3 outputs the ID information on a touch panel screen pop-up displayed to the screen control unit 54. Then a touch panel (e.g. numeral 45 shown in FIG. 3) for selecting any one of group articles is displayed on the display 5 via the display control unit 52.

Further, when the item code retrieved by the Menu retrieving unit 55-1 shows a set article, the deciding unit 55-3 outputs the item code to the set menu retrieving unit 55-4 and then displays a touch panel (e.g. refer to numeral 44 in FIG. 1) for selecting optional items forming the set menu.

In response to the item code from the deciding unit 55-3, the condiment retrieving unit 55-4 reads out a condiment menu by referring to the condiment chain 55b and then outputs it, together with ID information (POPUP ID) on a touch panel screen for selecting condiment articles, to the screen control unit 54.

In response to the item code from the deciding unit 55-3, the set menu retrieving unit 55-5 reads out a menu including basic items and optional items forming a set article by referring to the set menu master 55c and then outputs it to the screen control unit 54, together with ID information (POPUP ID) on a touch panel screen for selecting the optional items, to the screen control unit 54.

Further, the function key processing unit 55-6 takes out the next screen ID (the next screen ID to be displayed) for operating the function key corresponding to the button ID by referring to the trade process matrix 55d and then outputs it to the screen control unit 54, based on the button ID input from the ID deciding unit 54-2.

The combination of the screen control unit 54 and the display control unit 52 receives an item code from the deciding unit 55-3, ID information on a touch panel screen from the condiment retrieving unit 55-4 and the set menu retrieving unit 55-5, or the next screen ID from the function key processing unit 55-6, creates display data based on the screen information held and defined by the screen definition body 54a and the key definition body 54b, and then displays desired data on the display 5.

(d) Explanation of Operation of the POS terminal According to the Present Embodiment:

The operation of the merchandise order receiving POS terminal with the above-mentioned configuration according to an embodiment of the present invention will be described below using the flowcharts shown in FIG. 11 and FIGS. 20 to 24.

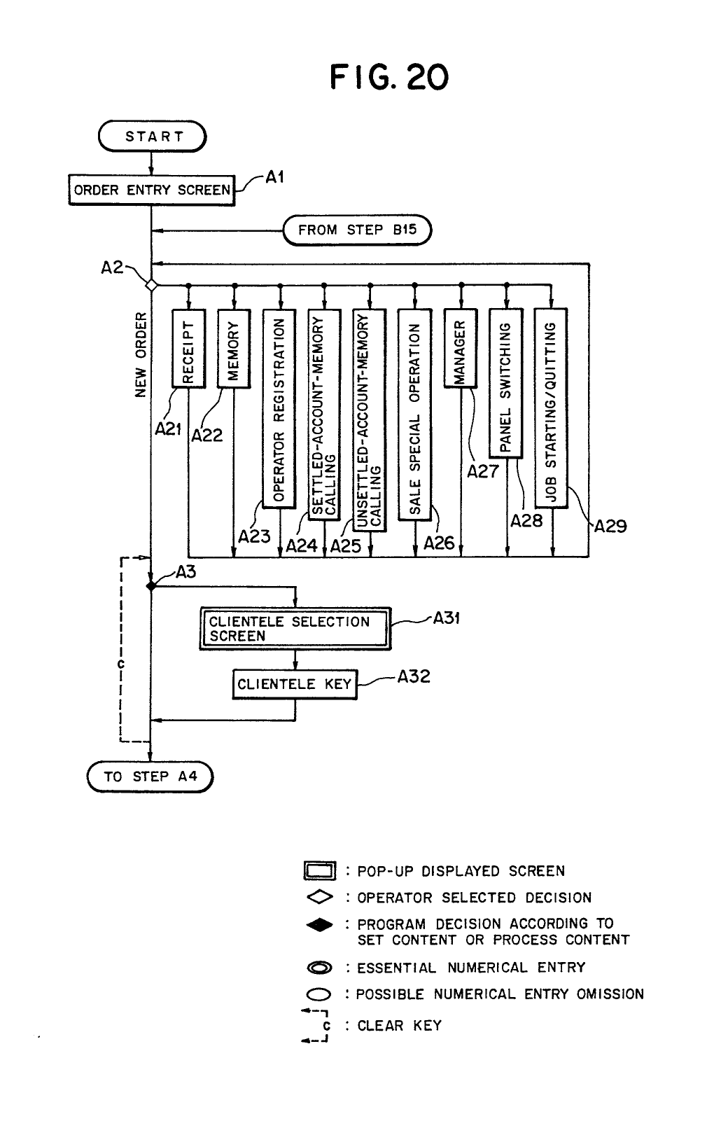

For example, when an operator operates the article order receiving POS terminal 4-1 installed at the check-out counter in a fast-food restaurant such as a hamburger shop, a touch panel 34 formed of plural keys for inputting article order receiving clienteles, for example, as shown in FIG. 11, is pop-up displayed as an initial screen on the display 5, together with the order entry screen 40 shown in FIG. 2 (step A1 in the flowchart shown in FIG. 20).

An operator performs various procedures of the POS terminal 4-1 and receives orders from customers by performing a desired key operation via the original screen shown in FIG. 11 (step A2).

In concrete, an operator operates desired keys in the function key unit 12 to perform as various operations of the POS terminal 4-1 a receipt issue, holding order information into the memory 7, operator registration, calling of the settled account memory 7a, a calling of the unsettled account memory 7b, sale special operation, manager operation, panel switching operation, work starting and ending registration, and receiving orders from customers (steps A21 to A29).

In order to receive order from a customer, the clientele is selectively input via the touch panel 34 shown in FIG. 11 (step A3, step A31 and step A32). When a clientele is input via the touch panel 34, the touch panel 34 pop-up displayed is released so that the POS terminal 4-1 is ready to perform an article registering process (order acceptance). However, when the clear key 12k is operated, the latest clientele entry becomes invalid.

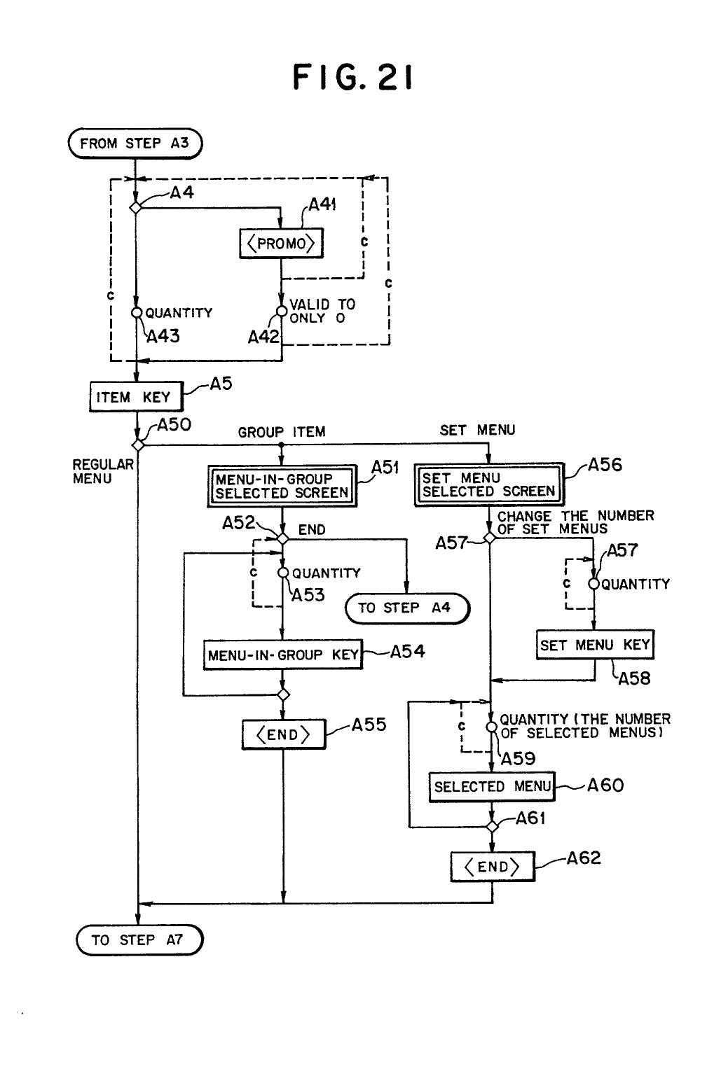

After the clientele has been input, the POS terminal 4-1 is in an order input wait state. That is, as shown with the flowchart in FIG. 21, after quantity is input via the ten key 11 (step A43), the item name corresponding to the quantity previously input is registered by operating the item key unit 13 (step A5).

When an operator operates the promo key 12f in the quantity entry to input a free promo, only the quantity of “0” is accepted (steps A41 and A42).

When the key operated in the item key unit 13 is a category key forming a group item, the touch panel is pop-up displayed to select an article in a menu in the group. For example, when the key 13d shown in FIG. 2 is operated, an operator can select an item among shakes by pop-up displaying the touch panel 45 shown in FIG. 3 (step A51).

In this case, an item name corresponding to the quantity previously input is registered by inputting quantity via the ten key 11 (step A53) and then operating a key (a menu key in a group) on the touch panel 45 pop-up displayed (step A54). However, when the clear key 12k is operated, the quantity input just before the operation becomes invalid.

When an end key among keys on the touch panel 45 pop-up displayed is operated without selecting a menu in a group, the pop-up display is released. The POS terminal 4-1 becomes the original order entry wait state (from step A52 to step A4).

Further, when a key on the item key unit 13 operated is the key for registering a set article (set menu), the touch panel 44 formed of keys corresponding to optional items in items forming the set article is pop-up displayed in the display 5 (step A56).

For example, when the key 13c shown in FIG. 2 is operated, the touch panel 44 which is formed of keys corresponding to the kind of optional drink among items forming a hamburger set is displayed. Thus an operator can select the type of drink.

Thereafter, when the quantity is input via the ten key 11 (step A59), an article corresponding to the quantity previously input is registered by operating a key on the touch panel 44 pop-up displayed (step A60). However, when the clear key 12k is operated, the quantity input just before the operation becomes invalid.

When the quantity of set menus is changed, the quantity to be changed is input via the ten key 11 (step A57). Then the touch panel 44 is pop-up displayed (step A58). Like the above case, an article is registered by inputting the quantity and kind of optional item (steps A59 and A60). In this case, when the clear key 12k is operated, the quantity input just before the operation becomes invalid.

Further, when the set article has been completely registered, an operator depresses the end key in the touch panel 44. However, till a designated and predetermined number of drinks are selected in the step A43, the pop-up display of the touch panel 44 is not released.

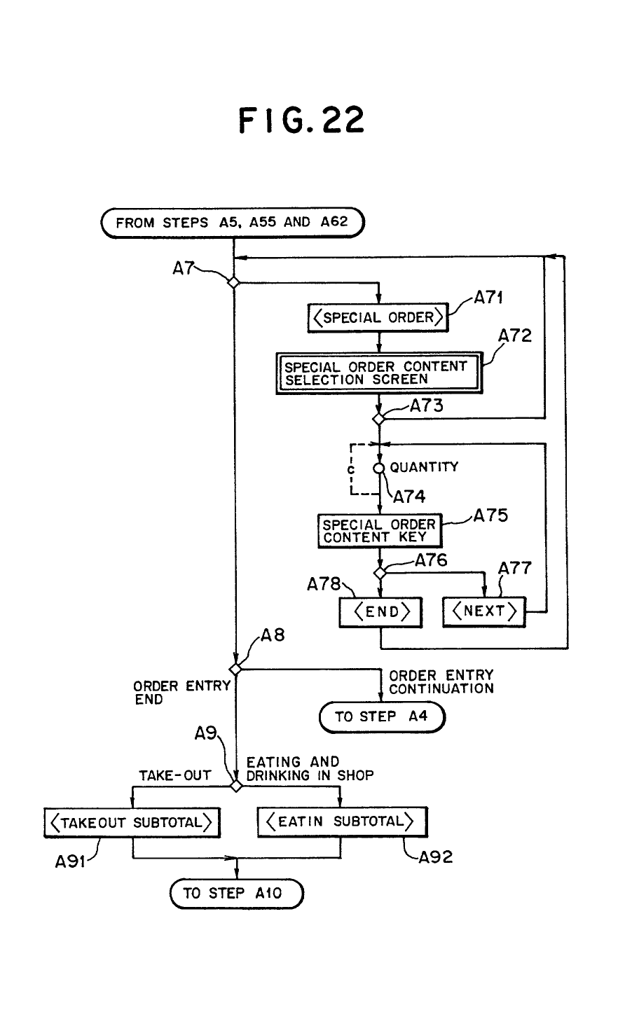

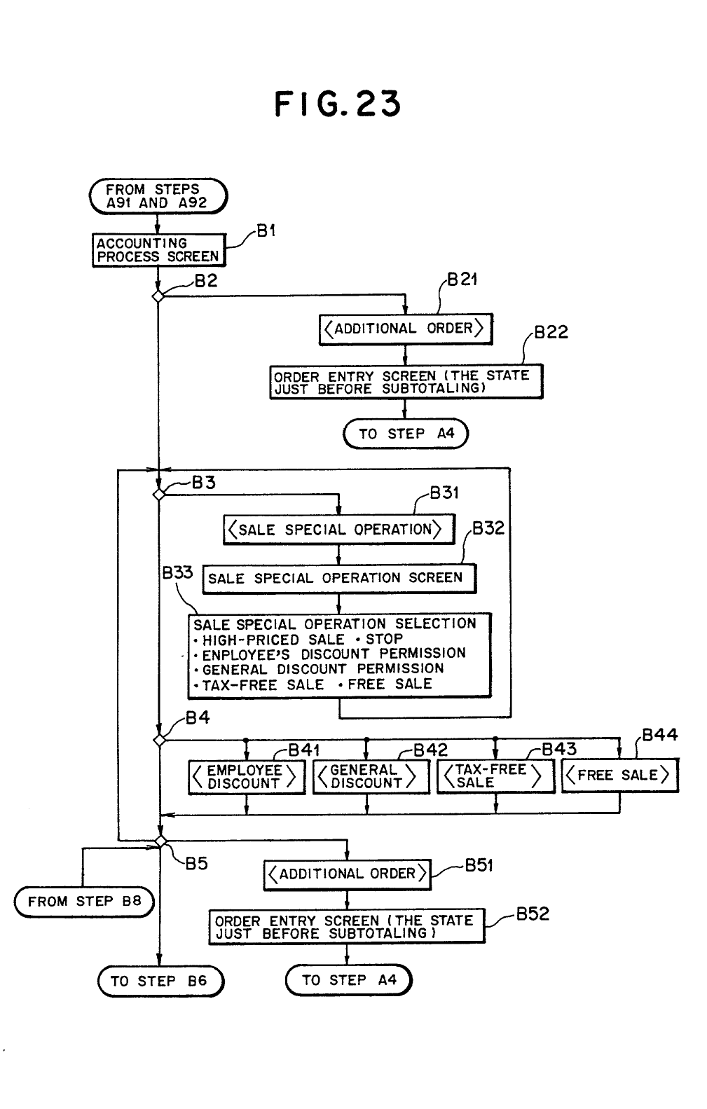

As described above, in the case where an item belonging to a group item or a set article is registered, or an item of a regular menu (a menu including one item) is registered, when the registered article is specially ordered, an operator operates according to the flowchart as shown in FIG. 22.

That is, when an operator depresses the special order key 12j (steps A7 and A71), the touch panel formed of the keys selecting the content of a special order is pop-up displayed (step A72).

Thereafter, after the quantity is input via the ten key 11 (step A74), the article and the quantity ordered with the content of a special order can be registered by operating the key pop-up displayed showing the content of the special order (step A75). In this case, when the clear key 12k is operated, the quantity input just before the operation becomes invalid.

After the touch panel formed of the keys for selecting the content of a special order is pop-up displayed, the operation for the special order is ended when a customer cancels his order or the special order is registered (steps A73, A76 and A78).

Further, when the special order is continued, the operation is repeated in the same manner as that above described (from steps A76 and A77 to steps A74 and A75).

When an order from a customer has been received by performing the order entry (article registration) of a regular menu, a menu belonging to a group item, or a set menu (step AS), an operator operates the take-out subtotal key 12n in a take-out trade or operates the eat-in subtotal key 12m in an eat-in trade (step A9 or A92).

When the eat-in subtotal key 12m or take-out sub-total key 12n is operated, the account screen 41 is displayed as shown in FIG. 5. Then the process is shifted from the article registering process to the accounting process according to the flowcharts shown in FIGS. 23 and 24 (step B1 in FIG. 23).

With the account screen 41 in a display state as shown in FIG. 5, when an additional order from a customer is received, by operating the additional order key 12A-13 (steps B2 and B21), the order entry screen 40 just before the display of the account screen 41 is displayed on the display 5 (step B22). In this operation, an operator can accept the additional order from the customer.

When the sale special operation including high-price sale, sale cancellation, employee discount permission, general discount permission, tax-free sale, or free sale is performed, the sale special operation screen to select any one of the various sale special operations is displayed by operating the sale special key 12a (steps B3, B31 and B32).

An operator can perform a desired sale special operation by selecting any one of various sale special operations displayed on the sale special operation screen and then operating the corresponding key (step B33). As to the sale special operation to which permission is needed, a desired sale special operation is performed after permission (steps B4 and B41 to B44).

When an additional order from a customer is received after the sale special operation, by operating the additional order key 12A-13 (steps B5 and B51), the order entry screen 40 just before the display of the account screen 41 is displayed on the display 5 (step B52). Thus, an operator can accept an additional order from the customer.

As described above, when there are no additional orders from a customer after the sale special operation out of necessity, an operator receives money for the item from a customer according to the flowchart shown in FIG. 24.

When a customer particularly wants to exchange directly money for an actual article, the trade information before payment is held in the unsettled account memory 7b by operating the memory key 12i. In such an operation, an operator can do other operations using the POS terminal 4-1 till the article is prepared.

Thereafter, when the ordered article is prepared, an operator operates the unsettled account memory calling key 12d to call the trade information out of the memory 7. Then money can be paid (to be described later) in exchange for the article by collating the article served to the customer with the detail statement information.

Even when it is needed to perform other process before payment, an operator holds the trade information before payment into the unsettled account memory 7b by operating the memory key 12i. Thereafter, at the end of the other process, the operator can continue the process by operating the unsettled account memory calling key 12d and extracting the trade information out of the memory 7.

Further, when a customer gives up his ordering in the middle of ordering articles, an operator operates the memory key 12i to store temporarily the order information into the unsettled account memory 7b. As a result, the operator can accept orders from customers lining behind without any delay. In this case, when there are no order waiting customers later, the order information can be read out through the operation of the unsettled account memory calling key 12d to cancel through the operation of the sale special key 12a.

When a customer pays by cash only for payment, the paid value is input (step B61 in FIG. 24). When the clear key 12k is operated, the money entry made just before the operation is invalidated.

Thereafter an operator calculates the sum in the trade by depressing the total key 12A-14 (step B62). That is, the operator takes changes out of the drawer automatically opened or puts changes into it (steps B10 to B12). The operator closes the drawer after the changes are paid or received (step B13). If necessary, the operator can issue a receipt by operating the receipt key 12e (step B111) or holds the information regarding the trade with the customer into the memory 7 by operating the memory key 12i (step B112).

When a customer pays by a GC/coupon ticket for payment, the operator inputs the number of the coupon tickets via the ten key 11A according to the kind of coupon ticket used for the payment and the kind of the coupon tickets via the GC/coupon keys 12A-6 to 12A-10 (steps B63 to B65). In this case, when the clear key 12k is depressed, the latest money entry is invalidated. Thereafter, the sum in the trade is calculated by depressing the total key 12A-14 (step B62).

When the payment is made using the coupon ticket, an operator notifies the customer of the balance of the value indicated thereon. If there is an additional order, it can be accepted by the balance of the coupon ticket, in the same manner as that in the step B5 (from step B8 to step B5).

If there are no additional orders, the operator takes the necessary changes out of the drawer automatically opened and then hands over the changes to the customer. Then, when the changes have been handed over, the operator closes the drawer (steps B10 to step B12). If necessary, the operator can issue a receipt by operating the receipt key 12e (step B111) and can hold the information regarding the trade with the customer into the memory 7 by operating the memory key 12i (step B112).

Further, when a customer pays by a credit card for payment, an operator displays the sale special operation screen on the display 5 by operating the sale special key 12a and then selects a credit on the sale special operation screen.

In such a procedure, a predetermined credit payment is made in the POS terminal 4-1 (steps B66 to B68 and step B62) and then the payment is completed by issuing a receipt as a detail credit payment statement (steps B9 and B91).

Further, when a customer uses a foreign currency for payment, an operator pop-up displays the foreign currency selection screen formed of keys for selecting foreign currencies by operating the foreign currency key 12A-5 (steps B69 and B70).

Thereafter, the operator operates the key corresponding to the foreign currency on the selection screen and then inputs the amount of money paid (step B61). In this case, when the clear key 12k is depressed, the latest money entry is invalidated (steps B71 to B73). Then the sum in the trade can be calculated in the same way as the payment in cash by depressing the total key 12A-14.

That is, the necessary changes are taken out of the drawer automatically opened (steps B10 to B12). The operator closes the drawer after handing over the changes (step B13). If necessary, the operator can issue a receipt by operating the receipt key 12e (steps B11 and B111) and can hold the information regarding the trade with the customer into the memory 7 by operating the memory key 12i (steps B11 and B112).

As described above, when an operator closes the drawer, the price of an article has been paid in cash, or with GC/coupon ticket, credit card or foreign currency. Then the screen on the display 5 returns automatically to the order entry screen 40 shown in FIG. 2 (step B14).

With the order entry screen 40 returned, an operator, if necessary, can issue a receipt regarding the latest trade by operating the receipt key 12e (steps B15 and B151) and then can hold information regarding the trade with the customer into the memory 7 by operating the memory key 12 (steps B15 and B152).

For example, when an ordered article cannot be prepared for a customer in spite of the payment completed because of an unready article, the information regarding the trade with the customer is held in the memory 7.

Thereafter, when the ordered article is prepared, the article for the customer can be collated with the detail statement information by operating the settled account memory calling key 12c and then extracting the trade information out of the memory 7.

(e) Explanation of the Functional Operation of the Merchandise Order Receiving POS Terminal According to the Present Embodiment:

Next, the functional operation of the merchandise order receiving POS terminal according to the present embodiment will be described below by referring to the flowcharts shown in FIGS. 13, 25, 26 and 27.

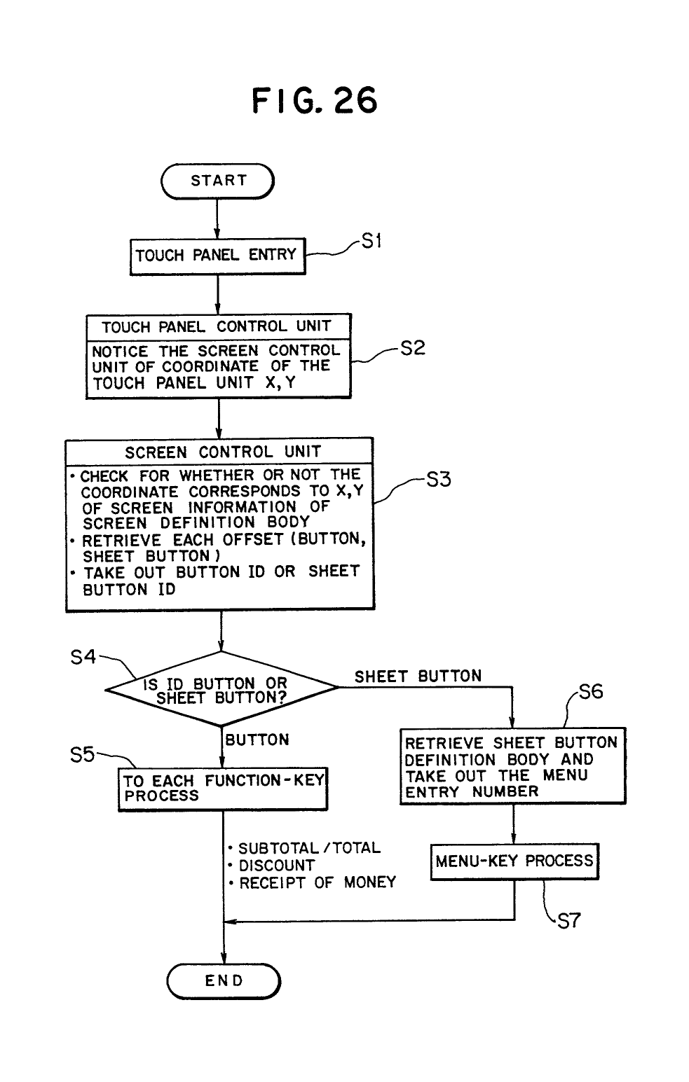

That is, an operator operates the POS terminals 4-1 to 4-n by touching a predetermined key (button) on the touch panel (e.g. screen ID=n order entry screen 58-(n+1); refer to numeral 40 in FIGS. 1 and 2) displayed on the display 5. The operator's operation on the screen is detected by the touch sensor 51 (step S1 in FIG. 26).

When the touch sensor 51 detects the operator's operation, the information on the detected operation is output as the position information (x, y coordinate values) on the display 5 operated by the operator to the screen control unit 54 via the touch panel control unit 53 (step S2).

Further, the ID detecting unit 54-1 detects the position of the key (button) on the corresponding screen while it refers to the screen definition body 54a, based on the position information (x, y coordinate values) from the touch panel control unit 53, and then outputs the detected result as key detection information.

In concrete, the ID detecting unit 54-1 checks for whether or not the position information (x, y coordinate values) from the touch panel control unit 53 is within the coordinate values (x, y) on the entire screen defined by the entire definition screen definition body 54a-1 (refer to FIG. 15).

When the operation information is within the coordinate values (x, y) of the defined entire screen, the text unit 60, the sheet text unit 61 and the button unit 63 defined in the entire definition screen definition body 54a-1 as well as the offset of a screen defined as the sheet button unit 64 are compared with the coordinate values (x, y) of the operation information. Thus the ID detecting unit 54-1 detects which of the text unit 60, the sheet text unit 61, the button unit 63 and the sheet button unit 64 the operation information corresponds to, and then outputs the detected result as key identification information (key ID information) (step S3).

In the operation of the button unit 63, the function key processing unit 55-6 extracts the next screen ID (the screen ID to be next displayed) for the operation of the function key corresponding to the button ID by referring to the trade process matrix 55d, based on the button ID input from the ID deciding unit 54-2, and then outputs it to the screen control unit 54. Thereafter, the operation is executed corresponding to the function key (steps S4 and S5).

When the sheet button unit 64 is operated, the sheet button/sheet text screen definition body 54a-4 is retrieved. Then the key position corresponding to the screen position operated by an operator is calculated based on the information regarding coordinate values (x, y), the number of rows and the number of columns in the sheet, and total quantity.

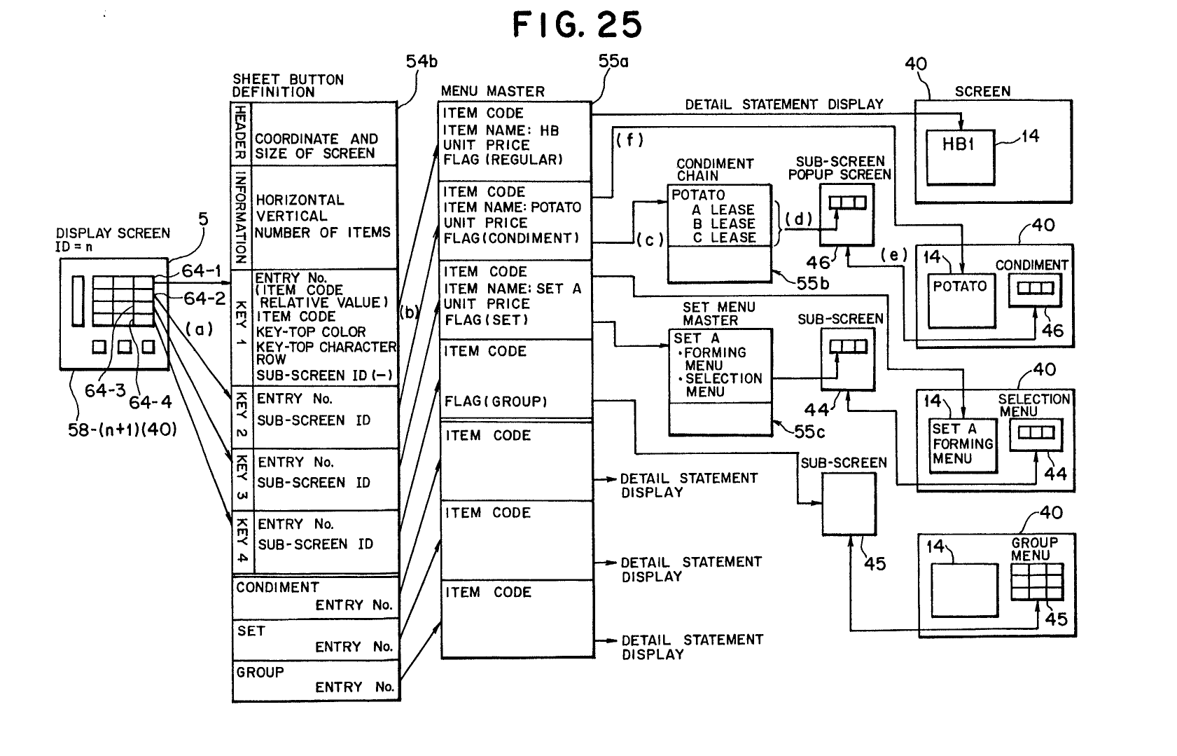

For example, when an operator depresses the sheet button 64-1 among the sheet buttons 64-1 to 64-4 on the order entry screen 58-(n+l) shown in FIG. 25, the ID detecting unit 54-1 works out the position of the key (button) on the corresponding screen by detecting the sheet button/sheet text screen definition body 54a-4 and then outputs as a detected result the ID information (sheet button ID) on the sheet button corresponding to the operated screen position (refer to step S3 and FIG. 25(a)).

Sequentially, the item entry number taking unit 54-3 reads out an item entry number, item code, key-top color, key-top character row and sub-screen ID by referring to the key definition body 54b based on the sheet button ID input via the ID detecting unit 54-1 and the ID deciding unit 54-2 and then outputs them to the menu retrieving unit 55-1 in the trade processing unit 55 (refer to steps S4 and S6 and FIG. 25(b)).

In this case, the sheet button ID corresponding to the operated screen position has “key 2” as key information. The item entry number, item code, key-top color, key-top character row and sub-screen ID are taken out by means of the “key 2” (partially shown in FIG. 25).

The menu retrieving unit 55-1 receives the item entry number from the item entry number extracting unit 54-3 and the sub-screen ID acting as an instruction for a pop-up display, and then takes out and outputs the item code of each item corresponding to an item entry number, item name, unit price, and flags showing the type of item, while referring to the menu master 55a.

In this case, the menu retrieving unit 55-1 takes out “Potato” as the item name corresponding to an item entry number as well as a condiment flag showing an optional condiment article as a flag showing the type of article.

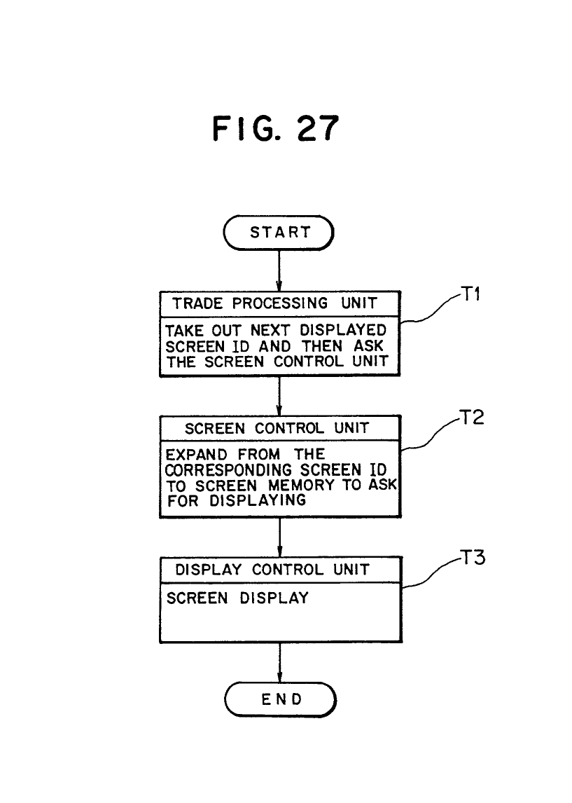

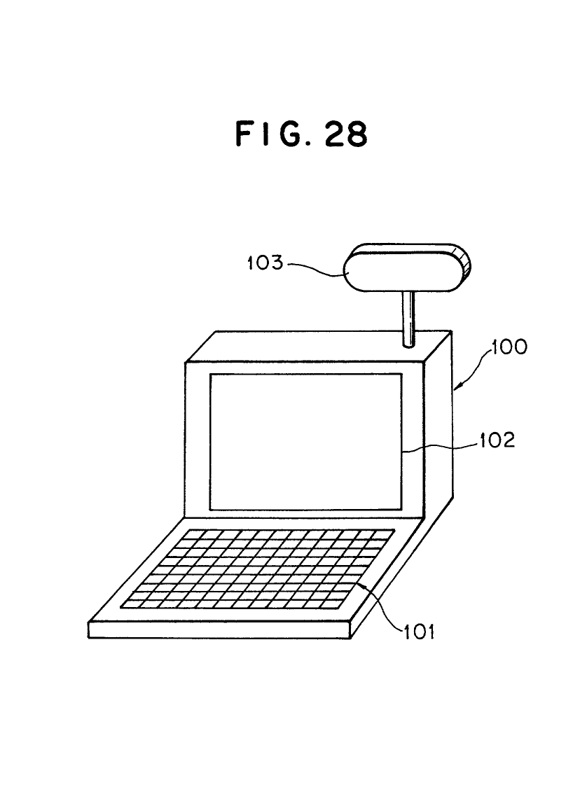

Thereafter, the condiment retrieving unit 55-4 receives an item code read out via the menu retrieving unit 55-1 and the deciding unit 55-3 (refer to FIG. 25(c)) and then reads out ID information (POPUP ID) on the screen showing the touch panel 46 used to select condiment articles by referring to the condiment chain 55b to output it to the screen control unit 54 (refer to step T1 in FIG. 27 and FIG. 25(d)).

The screen control unit 54 receives screen ID information from the trade processing unit 55 and then develops the screen on the memory 7 based on the screen ID information to ask the display control unit 52 for displaying (step T2). The display control unit 52 controls the display of the display 5 in response to a request from the screen control unit 54 (step T3).

Thus, for optional condiment articles, the touch panel 46 is pop-up displayed on the display 5 via the display control unit 52. As described above, the detail statement displaying unit 14 displays a usual detail statement of the item name “Potato” itself read out by the menu retrieving unit 55-1. Thereafter, an operator operates the touch panel 46 pop-up displayed (step S7).

When the sheet button 64-1 corresponding to a regular one item menu, the sheet button 64-3 corresponding to an article belonging to a group article, or the sheet button 64-4 corresponding to a set menu is operated, they are displayed on the display 5 according to the process procedure basically similar to that in the above-mentioned case.

In the order receiving POS terminal according to an embodiment of the present invention, the touch panel formed of keys corresponding to optional items in an article registering operation can be pop-up displayed on the display 5. Hence, the POS terminals 4-1 to 4-n can be operated by operating the pop-up displayed touch panel while the original screen image is left, without deteriorating the entire operational flow. Hence there is the advantage in that the remarkably improved operability increases the serviceability to an operator.

When a set article in which plural items are combined is ordered, the basic items in the set article can be displayed as registered items on the display 5 while the touch panel 24 formed of keys corresponding to an optional item except the basic items in the set article can be pop-up displayed on the screen 5. The detail statement about the optional item in the set article can be displayed on the display 5. Hence, the same advantage as that in the above-mentioned case can be obtained. Further, the sales can be accurately managed by registering all items of a set article.

Further, when a predetermined number of optional items except the basic items are selected and registered using the touch panel 24, the pop-up display on the display 5 can be released. Hence, since an erroneous input of an operator can be prevented, the operability can be significantly improved.

The same kind of articles are displayed as one category key 13d on the display 5. When the category key 13d is operated, the touch panel 25 formed of the keys corresponding to the kind of article belonging to the category key 13d can be pop-up displayed as an article table on the display 5. Hence if plural items can be categorized as the same kind of items, the item registration keys displayed on the order entry screen 40 can be united as a single key, thus contributing to decreasing the number of keys on the order entry screen 40. There is the advantage in that the screen visibility as well as the operability by an operator can be significantly improved.

Further, since the touch panel formed of keys corresponding to items changed according to time slots can be displayed on the display 5, the number of keys on the order entry screen 40 can be decreased like the above-mentioned case. Hence, there is the advantage in that the screen visibility as well as the operability by an operator can be significantly improved.

When payment is made for an article ordered by a customer, information on the detail statement thereof is displayed on the display 5 while the order confirmation key 12A-12 can be displayed on the display 5 to enlarge the item detail statement information. Hence, by operating the order confirmation key 12A-12, an operator can confirm whether or not the prepared article agrees with information regarding the registered article at the place remote from the POS terminals 4-1 to 4-n, just before the article is handed over to the customer.

Further, even when other process is needed after or before payment, an operator can perform quickly other process by operating and displaying the memory key 12i and the memory calling keys 12c and 12d while data in the middle of processing is being held. Hence there is the advantage in that an operator can perform the process without delay.

When the memory calling keys 12c and 12d are operated to call out the order information before completion of a trade, the control unit 8 can erase the order information held in the memory 7. Hence unnecessary data can be erased without any special operation by an operator while the processed data is not erroneously mistaken with data in process. There is the advantage in that the serviceability to an operator can be provided.

(f) Others:

In the detail explanation of the above-mentioned embodiments, the POS system has been applied to the management system for fast-food restaurants such as hamburger shops chain developed. However, the present invention should not be limited only to the above-mentioned embodiments. The present invention can be applied to the management system for different types of restaurants.

What is claimed is:

1. A panel displaying method of an order receiving POS (Point-Of-Sales) terminal, wherein said POS terminal includes a display unit that displays a touch panel formed of plural keys operated when an order for an article from a customer is received, comprising the step of:
pop-up displaying on said display unit a touch panel formed of keys each corresponding to an optional item when said article is ordered.

2. A panel displaying method of an order receiving POS (Point-Of-Sales) terminal, wherein said POS terminal includes a display unit that displays a touch panel formed of plural keys operated when an order for an article from a customer is received, comprising the step of:
displaying a base item in a set article as a registered article on said display unit and pop-up displaying on said display unit a touch panel formed of keys each corresponding to an optional item other than said base item in said set article, when said set article including plural items is ordered.

3. The panel displaying method of an order receiving POS terminal according to claim 1, further comprising the step of releasing the pop-up display on said display unit when said optional item other than said base item is selectively registered.

4. The panel displaying method of an order receiving POS terminal according to claim 2, further comprising the step of releasing the pop-up display on said display unit when said optional item other than said base item is selectively registered.

5. A panel displaying method of an order receiving POS (Point-Of-Sales) terminal, wherein said POS terminal includes a display unit that displays a touch panel formed of plural keys operated when an order for an article from a customer is received, comprising the steps of:
displaying the same kind of articles as a category key on said display unit; and
pop-up displaying on said display unit a touch panel formed of keys corresponding to the kind of articles belonging to said category key as an article menu when said category key is operated.

6. A panel displaying method of an order receiving POS (Point-Of-Sales) terminal, wherein said POS terminal includes a display unit that displays a touch panel formed of plural keys operated when an order for an article from a customer is received, comprising the step of:
displaying on said display unit a touch panel formed of keys corresponding to articles changed according to time slot.

7. A panel displaying method of an order receiving POS (Point-Of-Sales) terminal, wherein said POS terminal includes a display unit that displays a touch panel formed of plural keys operated when an order for an article from a customer is received, comprising the steps of:
displaying on said display unit the information on a detailed statement of an article ordered by said customer when said customer pays for said article ordered; and
displaying an enlarged display key to display enlargedly information regarding said detailed statement of said article on said display unit.

8. A panel displaying method of an order receiving POS (Point-Of-Sales) terminal, wherein said POS terminal includes a display unit that displays a touch panel formed of plural keys operated when an order for an article from a customer is received, comprising the step of:
displaying a touch panel having a memory key for temporarily holding order information before completion of a trade with said customer into a memory and a memory calling key for displaying said order information before completion of the trade stored in said memory, on said display unit.

9. The panel displaying method of an order receiving POS terminal according to claim 8, further comprising the step of:
displaying a screen to register an article on said display unit when said order information is information regarding that a customer's payment has been completed and displaying a screen for said payment on said display unit when said order information is information regarding that a customer's payment has not been completed, when said order information before completion of the trade is read out by operating said memory calling key.

10. An order receiving POS terminal comprising:
a display unit for displaying a touch panel formed of plural keys operated when an order for an article from a customer is received;
a memory for temporarily storing order information registered via said touch panel; and
a control unit for controlling content of said memory and display mode of said display unit according to operation of said touch panel;
said touch panel forming said display unit including a memory key for temporarily storing said order information before completion of said customer's trade into said memory via said control unit, and a memory calling key for displaying said order information before completion of the trade stored in said memory.

11. The order receiving POS terminal according to claim 10, wherein said control unit erases said order information stored in said memory when said order information before completion of the trade is called out by operation of said memory calling key.

12. The order receiving POS terminal according to claim 10, wherein said job of receiving an order for articles from a customer comprises an article registering process for registering an article ordered by a customer; and a paying process for paying said article registered.
